(19) United States
(12) Patent Application Publication
(10) Pub. No.: US 2013/0300740 A1
(43) Pub. Date: Nov. 14, 2013

(54) System and Method for Displaying Data Having Spatial Coordinates

(71) Applicants: Mark Snyder, Glendale, AZ (US); Carlos Gameros, Surprise, AZ (US); Peter Daniel, Goodyear, AZ (US); Richard Seale, Peoria, AZ (US)

(72) Inventors: Mark Snyder, Glendale, AZ (US); Carlos Gameros, Surprise, AZ (US); Peter Daniel, Goodyear, AZ (US); Richard Seale, Peoria, AZ (US)

(73) Assignee: ALT Software (US) LLC, Phoenix, AZ (US)

(21) Appl. No.: 13/823,045

(22) PCT Filed: Sep. 13, 2011
(86) PCT No.: PCT/US2011/051445

§ 371 Date: Aug. 1, 2013

Related U.S. Application Data
(60) Provisional application No. 61/382,408, filed on Sep. 13, 2010.

(51) Int. Cl. G06T 17/00

(52) U.S. Cl. CPC G06T 17/00
USPC 345/420; 345/419

(57) ABSTRACT

Systems and methods are provided for displaying data, such as 3D models, having spatial coordinates. In one aspect, a height map and color map are generated from the data. In another aspect, material classification is applied to surfaces within a 3D model. Based on the 3D model, the height map, the color map, and the material classification, haptic responses are generated on a haptic device. In another aspect, a 3D user interface (UI) data model comprising model definitions is derived from the 3D models. The 3D model is updated with video data. In another aspect, user controls are provided to navigate a point of view through the 3D model to determine which portions of the 3D model are displayed.

### CROSS REFERENCE TO RELATED APPLICATIONS

The present application claims priority from U.S. Provisional Application No. 61/382,408 filed on Sep. 13, 2010, the entire contents of which are hereby incorporated by reference.

### TECHNICAL FIELD

The following relates generally to the display of data generated from or representing spatial coordinates.

### DESCRIPTION OF THE RELATED ART

In order to investigate an object or structure, it is known to interrogate the object or structure and collect data resulting from the interrogation. The nature of the interrogation will depend on the characteristics of the object or structure. The interrogation will typically be a scan by a beam of energy propagated under controlled conditions. Other types of scanning include passive scans, such as algorithms that recover point cloud data from video or camera images. The results of the scan are stored as a collection of data points, and the position of the data points in an arbitrary frame of reference is encoded as a set of spatial-coordinates. In this way, the relative positioning of the data points can be determined and the required information extracted from them.

Data having spatial coordinates may include data collected by electromagnetic sensors of remote sensing devices, which may be of either the active or the passive types. Non-limiting examples include LiDAR (Light Detection and Ranging), RADAR, SAR (Synthetic-aperture RADAR), IFSAR (Interferometric Synthetic Aperture Radar) and Satellite Imagery. Other examples include various types of 3D scanners and may include sonar and ultrasound scanners.

LiDAR refers to a laser scanning process which is usually performed by a laser scanning device from the air, from a moving vehicle or from a stationary tripod. The process typically generates spatial data encoded with three dimensional spatial data coordinates having XYZ values and which together represent a virtual cloud of 3D point data in space or a “point cloud”. Each data element or 3D point may also include an attribute of intensity, which is a measure of the level of reflectance at that spatial data coordinate, and often includes attributes of RGB, which are the red, green and blue color values associated with that spatial data coordinate. Other attributes such as first and last return and waveform data may also be associated with each spatial data coordinate. These attributes are useful both when extracting information from the point cloud data and for visualizing the point cloud data. It can be appreciated that data from other types of sensing devices may also have similar or other attributes.

The visualization of point cloud data can reveal to the human eye a great deal of information about the various objects which have been scanned. Information can also be manually extracted from the point cloud data and represented in other forms such as 3D vector points, lines and polygons, or as 3D wire frames, shells and surfaces. These forms of data can then be input into many existing systems and workflows for use in many different industries including for example, engineering, architecture, construction and surveying.

A common approach for extracting these types of information from 3D point cloud data involves subjective manual pointing at points representing a particular feature within the point cloud data either in a virtual 3D view or on 2D plans, cross sections and profiles. The collection of selected points is then used as a representation of an object. Some semi-automated software and CAD tools exist to streamline the manual process including snapping to improve pointing accuracy and spline fitting of curves and surfaces. Such a process is tedious and time consuming. Accordingly, methods and systems that better semi-automate and automate the extraction of these geometric features from the point cloud data are highly desirable.

Automation of the process is, however, difficult as it is necessary to recognize which data points form a certain type of object. For example, in an urban setting, some data points may represent a building, some data points may represent a tree, and some data points may represent the ground. These points coexist within the point cloud and their segregation is not trivial.

Automation may also be desired when there are many data points in a point cloud. It is not unusual to have millions of data points in a point cloud. Displaying the information generated from the point cloud can be difficult, especially on devices with limited computing resources such as mobile devices.

From the above it can be understood that efficient and automated methods and systems for extracting features from 3D spatial coordinate data, as well as displaying the generated data, are highly desirable.

### BRIEF DESCRIPTION OF THE DRAWINGS

Embodiments of the invention or inventions will now be described by way of example only with reference to the appended drawings wherein:

FIG. 1 is a schematic diagram to illustrate an example of an aircraft and a ground vehicle using sensors to collect data points of a landscape.

FIG. 2 is a block diagram of an example embodiment of a computing device and example software components.

FIG. 3 is a block diagram of example display software components.

FIG. 4 is a flow diagram illustrating example computer executable instructions for displaying 3D spatial data.

FIGS. 5(a) to 5(h) are schematic diagrams illustrating example stages for generating a height map from data points having spatial coordinates.

FIG. 6 is a flow diagram illustrating example computer executable instructions for generating a height map from data points having spatial coordinates.

FIG. 7 is a flow diagram illustrating example computer executable instructions for generating a color map from data points having spatial coordinates and color data.

FIG. 8 is a flow diagram illustrating example computer executable instructions for classifying material based on at least one of a color map and a height map.

FIG. 9 is a flow diagram illustrating example computer executable instructions for classifying material specific to building walls and roofs.

FIG. 10 is a flow diagram illustrating example computer executable instructions continued from FIG. 9.

FIG. 11 is block diagram of the computing device of FIG. 2 illustrating components suitable for displaying 3D models and a user interface for the same.

FIG. 12 is a block diagram of another example computing device illustrating components suitable for displaying a user interface, receiving user inputs, and providing haptic feedback.

FIG. 13 is a schematic diagram illustrating example data and hardware components for generating haptic feedback on a mobile device based on the display of a 3D scene.

FIG. 14 is a flow diagram illustrating example computer executable instructions for generating haptic feedback.

FIG. 15 is an example screen shot of a windowing interface within a 3D scene, showing components used for clipping.

FIG. 16 is another example screen shot of a windowing interface within a 3D scene.

FIG. 17 is a flow diagram illustrating example computer executable instructions for clipping images in a 3D user interface (UI) window.

FIGS. 18(a) and 18(b) are schematic diagrams illustrating example stages in the method of clipping in a 3D UI window.

FIG. 19 is a flow diagram illustrating example computer executable instructions for visually rendering objects based on the Z-order in a 3D UI window.

FIG. 20 is a schematic diagram illustrating example stages in the method of visually rendering objects based on the Z-order in a 3D UI window.

FIG. 21 is a flow diagram illustrating example computer executable instructions for detecting and processing interactions between a pointer or cursor and a 3D scene being displayed.

FIG. 22 is a block diagram of data components in an example scene management system.

FIG. 23 is a block diagram illustrating the data structure of a model definition.

FIG. 24 is a block diagram illustrating the data structure of a model instance.

FIG. 25 is a block diagram illustrating example components of a 3D UI execution engine for executing instructions to process the data components of FIGS. 22, 23 and 24.

FIG. 26 is a schematic diagram illustrating another example of data components in a scene management system for 3D UI windowing.

FIG. 27 is a schematic diagram illustrating example data and hardware components for encoding a 3D model with video data and displaying the same.

FIG. 28 is a flow diagram illustrating example computer executable instructions for encoding a 3D model with video data.

FIG. 29 is a flow diagram illustrating example computer executable instructions for decoding the 3D model and video data and displaying the same.

FIG. 30 is a schematic diagram illustrating different virtual camera positions based on different azimuth and elevation angles relative to a focus point.

FIG. 31 is an example screen shot of a graphical user interface (GUI) for navigating through a 3D scene.

FIG. 32 is another example screen shot of a GUI for navigating through a 3D scene.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The proposed systems and methods display the data generated from the data points having spatial coordinates. The processing and display of the data may be carried out automatically by a computing device.

As discussed above, the data may be collected from various types of sensors. A non-limiting example of such a sensor is the LiDAR system built by Ambercore Software Inc, and available under the trade-mark TITAN.

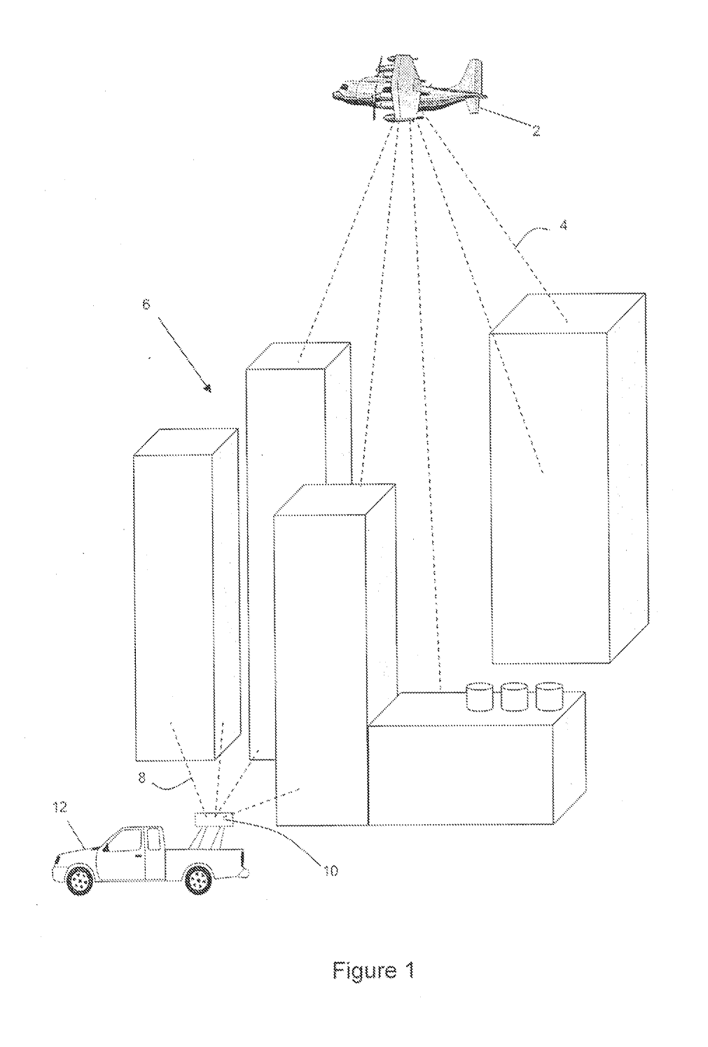

Turning to FIG. 1, data is collected using one or more sensors 10 mounted to an aircraft 2 or to a ground vehicle 12. The aircraft 2 may fly over a landscape 6 (e.g. an urban landscape, a suburban landscape, a rural or isolated landscape) while a sensor collects data points about the landscape 6. For example, if a LiDAR system is used, the LiDAR sensor 10 would emit lasers 4 and collect the laser reflection. Similar principles apply when an electromagnetic sensor 10 is mounted to a ground vehicle 12. For example, when the ground vehicle 12 drives through the landscape 6, a LiDAR system may emit lasers 8 to collect data. It can be readily understood that the collected data may be stored onto a memory device. Data points that have been collected from various sensors (e.g. airborne sensors, ground vehicle sensors, stationary sensors) can be merged together to form a point cloud.

Each of the collected data points is associated with respective spatial coordinates which may be in the form of three dimensional spatial data coordinates, such as XYZ Cartesian coordinates (or alternatively a radius and two angles representing Polar coordinates). Each of the data points also has numeric attributes indicative of a particular characteristic, such as intensity values, RGB values, first and last return values and waveform data, which may be used as part of the filtering process. In one example embodiment, the RGB values may be measured from an imaging camera and matched to a data point sharing the same coordinates.

The determination of the coordinates for each point is performed using known algorithms to combine location data, e.g. GPS data, of the sensor with the sensor readings to obtain a location of each point with an arbitrary frame of reference.

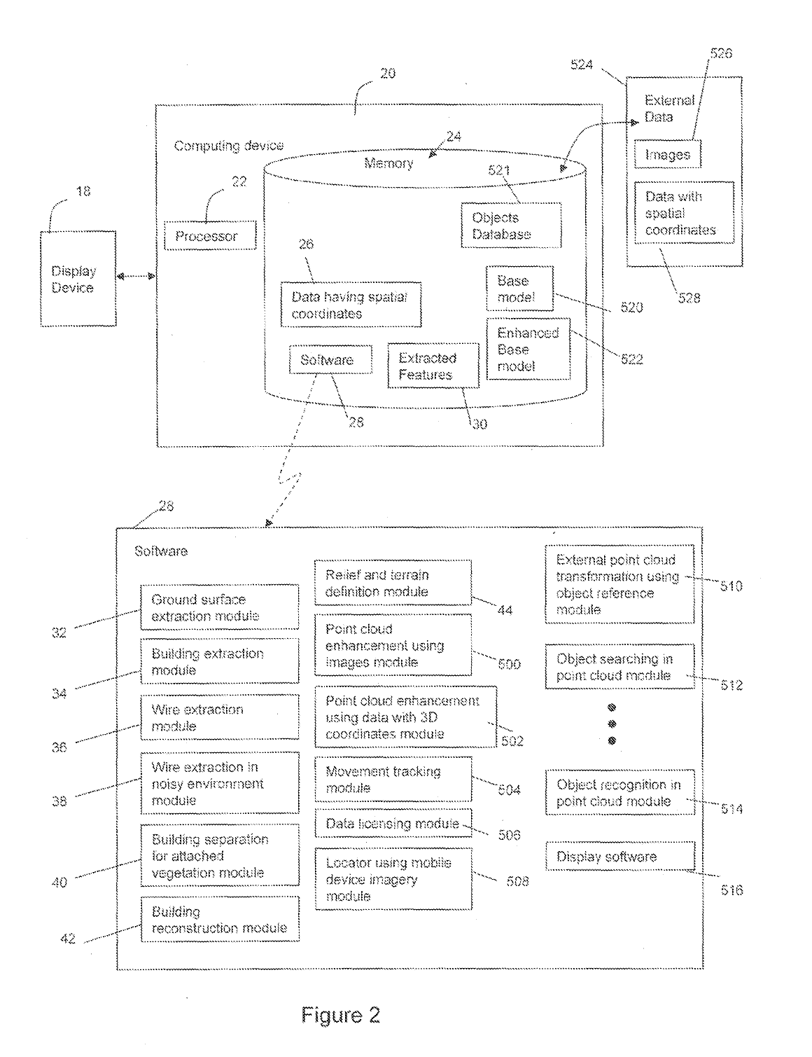

Turning to FIG. 2, a computing device 20 includes a processor 22 and memory 24. The memory 24 communicates with the processor 22 to process data. It can be appreciated that various types of computer configurations (e.g. networked servers, standalone computers, cloud computing, etc.) are applicable to the principles described herein. The data having spatial coordinates 26 and various software 28 reside in the memory 24. A display device 18 may also be in communication with the processor 22 to display 2D or 3D images based on the data having spatial coordinates 26.

It can be appreciated that the data 26 may be processed according to various computer executable operations or instructions stored in the software. In this way, the features may be extracted from the data 26.

Continuing with FIG. 2, the software 28 may include a number of different modules for extracting different features from the data 26. For example, a ground surface extraction module 32 may be used to identify and extract data points that are considered the “ground”. A building extraction module 34 may include computer executable instructions or operations for identifying and extracting data points that are considered to be part of a building. A wire extraction module 36 may include computer executable instructions or operations for identifying and extracting data points that are considered to be part of an elongate object (e.g. pipe, cable, rope, etc.), which is herein referred to as a wire. Another wire extraction module 38 adapted for a noisy environment 38 may include computer executable instructions or operations for identifying and extracting data points in a noisy environment that are considered to be part of a wire. The software 28 may also include a module 40 for separating buildings from attached vegetation. Another module 42 may include computer executable instructions or operations for reconstructing a building. There may also be a relief and terrain definition module 44. Some of the modules use point data of the buildings' roofs. For example, modules 34, 40 and 42 use data points of a building's roof and, thus, are likely to use data points that have been collected from overhead (e.g. an airborne sensor).

It can be appreciated that there may be many other different modules for extracting features from the data having spatial coordinates 26.

Continuing with FIG. 2, the features extracted from the software 28 may be stored as data objects in an “extracted features” database 30 for future retrieval and analysis. For example, features (e.g. buildings, vegetation, terrain classification, relief classification, power lines, etc.) that have been extracted from the data (e.g. point cloud) 26 are considered separate entities or data objects, which are stored the database 30. It can be appreciated that the extracted features or data objects may be searched or organized using various different approaches.

Also shown in the memory 24 is a database 520 storing one or more base models. There is also a database 522 storing one or more enhanced base models. Each base model within the base model database 520 comprises a set of data having spatial coordinates, such as those described with respect to data 26. A base model may also include extracted features 30, which have been extracted from the data 26. As will be discussed later below, a base model 522 may be enhanced with external data 524, thereby creating enhanced base models. Enhanced base models also comprise a set of data having spatial coordinates, although some aspect of the data is enhanced (e.g. more data points, different data types, etc.). The external data 524 can include images 526 (e.g. 2D images) and ancillary data having spatial coordinates 528.

An objects database 521 is also provided to store objects associated with certain base models. An object, comprising a number of data points, a wire frame, or a shell, has a known shape and known dimensions. Non-limiting examples of objects include buildings, wires, trees, cars, shoes, light poles, boats, etc. The objects may include those features that have been extracted from the data having spatial coordinates 26 and stored in the extracted features database 30. The objects may also include extracted features from a base model or enhanced base model.

FIG. 2 also shows that the software 28 includes a module 500 for point cloud enhancement using images. The software 28 also includes a module 502 for point cloud enhancement using data with 3D coordinates. There may also be a module 504 for movement tracking (e.g. monitoring or surveillance). There may also be another module 506 for licensing the data (e.g. the data in the databases 25, 30, 520 and 522). The software 28 also includes a module 508 for determining the location of a mobile device or objects viewed by a mobile device based on the images captured by the mobile device. There may also be a module 510 for transforming an external point cloud using an object reference, such as an object from the objects database 521. There may also be a module 512 for searching for an object in a point cloud. There may also be a module 514 for recognizing an unidentified object in a point cloud. It can be appreciated that there may be many other different modules for manipulating and using data having spatial coordinates. For example, there may also be one or more display modules 516 that is able to process and display the data related to any one, or combinations thereof, of the point cloud 26, objects database 521, extracted features 30, base model 520, enhanced based model 522, and external data 524. It can also be understood that many of the modules described herein can be combined with one another.

Many of the above modules are described in further detail in U.S. Patent Application No. 61/319,785 and U.S. Patent Application No. 61/353,939, whereby both patent applications are herein incorporated by reference in their entirety.

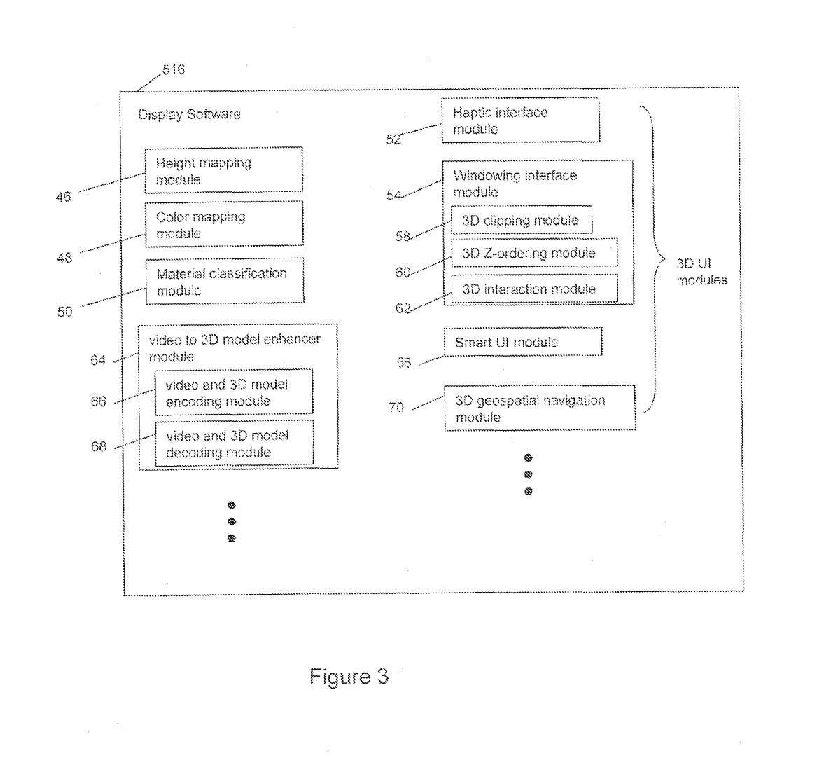

Turning to FIG. 3, examples ones of display modules 516 are provided. Module 46 is for generating a height map or bump map for an image based on data with spatial coordinates. There may also be a module 48 for generating a color map for an image, also based on data with spatial coordinates. Module 50 is for classifying materials of an object shown in an image, whereby the image is associated with at least one of a height map and a color map. Module 52 is for providing haptic feedback when a user interacts with images or the 3D models of objects. Module 54 is for providing a windowing interface in a 3D model. Module 54 includes a 3D clipping module 58, a Z-ordering module 60, a 3D interaction module 62. Modules 58, 60, and 62 can be used to display a window in a 3D model. Module 64 is for enhancing a 3D model using video data. Module 64 includes a video and 3D model encoding module 66 and a video and 3D model decoding module 68. Module 56 is for managing a “smart user interface (UI)” by defining data structures. Module 70 is for navigating through the geography and space of a 3D model. Modules 52, 54, 56, and 70 are considered 3D UI modules as they relate to user interaction with the display of the data. These modules are discussed further below.

The display modules described herein provide methods for encoding, transmitting, and displaying highly detailed data on computer-limited display systems, such as mobile devices, smart phones, PDAs, etc. Highly detailed point cloud models can consist of hundred's of thousands, or even millions, of data points. It is recognized that using such detailed models on a viewing device that has limited computing and graphics power is difficult, and the challenge for doing so is significant.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology. CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing device 20 or accessible or connectable thereto. Any application or module herein described may be implemented using computer readable/executable instructions or operations that may be stored or otherwise held by such computer readable media.

Details regarding the different display systems and methods, that may be associated with the various modules in the display software 516, will now be discussed.

In the display of data, three-dimensional detail can be represented using parametric means, such as representing surface contours using NURBS (Non-Uniform Rational B-Spline) and other curved surface parameters. However, this approach is difficult to compute and expensive to render, and is most suitable for character rendering. Often times, artificial detail is ‘created’ via use of fractals, to give the appearance of detail where it does not exist. However, while this might make a pleasing visual picture, it does not represent the true object. Other means to represent detail include representing successively higher resolution datasets as a ‘pyramid’ whereby high resolution data is transmitted when a closer ‘zoom’ level is desired. This method breaks down when the best (e.g. highest) level of detail exceeds the ability of the transmission link or the ability of the computer to support the data volume. Moreover, higher resolution data is very large and not very well suited to compression. Many systems also employ ‘draping’ of a two-dimensional image over three-dimensional surfaces. This gives a visual appearance that may resemble a realistic 3D surface, but suffers from visual artefacts. For example, when draping a 2D image of a building with trees in the foreground, the image being draped on a 3D model of a building, the result will be flattened trees along the sides of the 3D building. Furthermore, this is only suitable for basic visual rendering techniques such as daytime lighting. By providing systems and method for height mapping and color mapping, one or more of the above issues can be addressed.

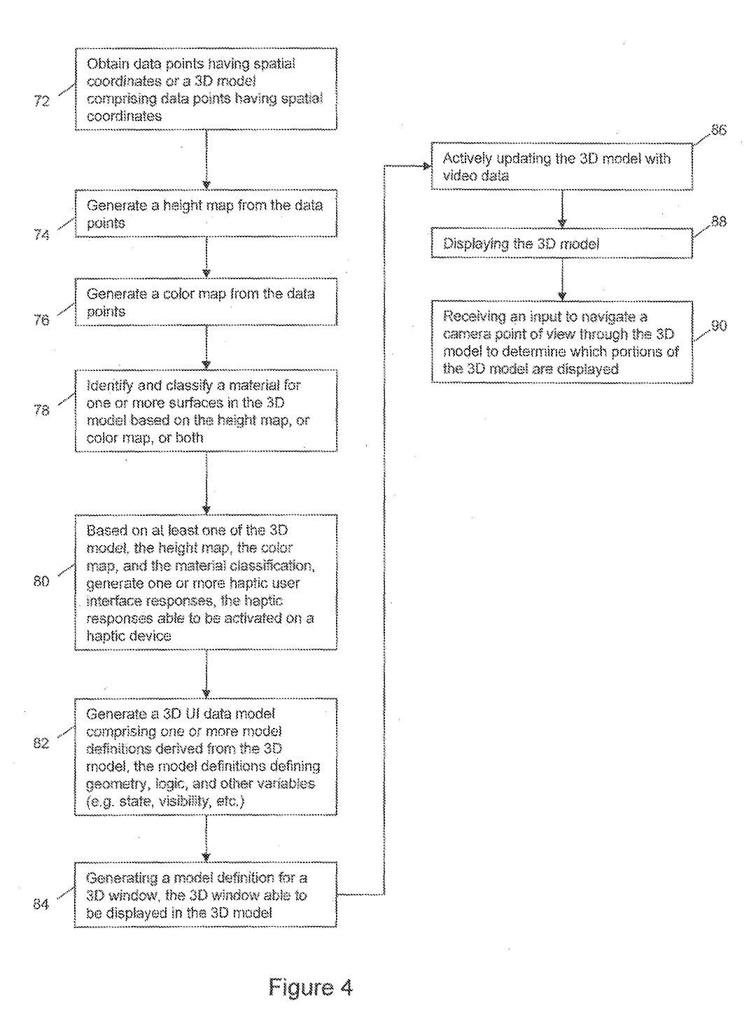

Turning to FIG. 4, computer executable instructions are provided for displaying data using the modules in the display software 516. At block 72, data points having spatial coordinates are obtained. Alternatively, a 3D model is obtained, whereby the 3D model comprises data points having spatial coordinates. At block 74, a height map from the data points is generated (e.g. using module 46). At block 76, a color map is generated from the data points (e.g. using module 48). At block 78, one or more surfaces in the 3D models are identified and the materials of the surfaces are classified using the height map, or the color map, or both (e.g. using module 50). At block 80, based on at least one of the 3D model, the height map, the color map, and the material classification, one or more haptic user interface responses are generated (e.g. using module 52). The haptic responses are able to be activated on a haptic device. At block 82, a 3D UI data model is generated (e.g. using module 56). The 3D UI data model comprises one or more model definitions derived from the 3D model, the model definitions defining geometry, logic, and other variables (e.g. state, visibility, etc.). At block 84, a model definition for a 3D window is generated (e.g. using module 54). The 3D window is able to be displayed in the 3D model. At block 86, the 3D model is actively updated with video data (e.g. using module 64). At block 88, the 3D model is displayed. At block 90, an input is received to navigate a point of view through the 3D model to determine which portions of the 3D model are displayed (e.g. using module 70).

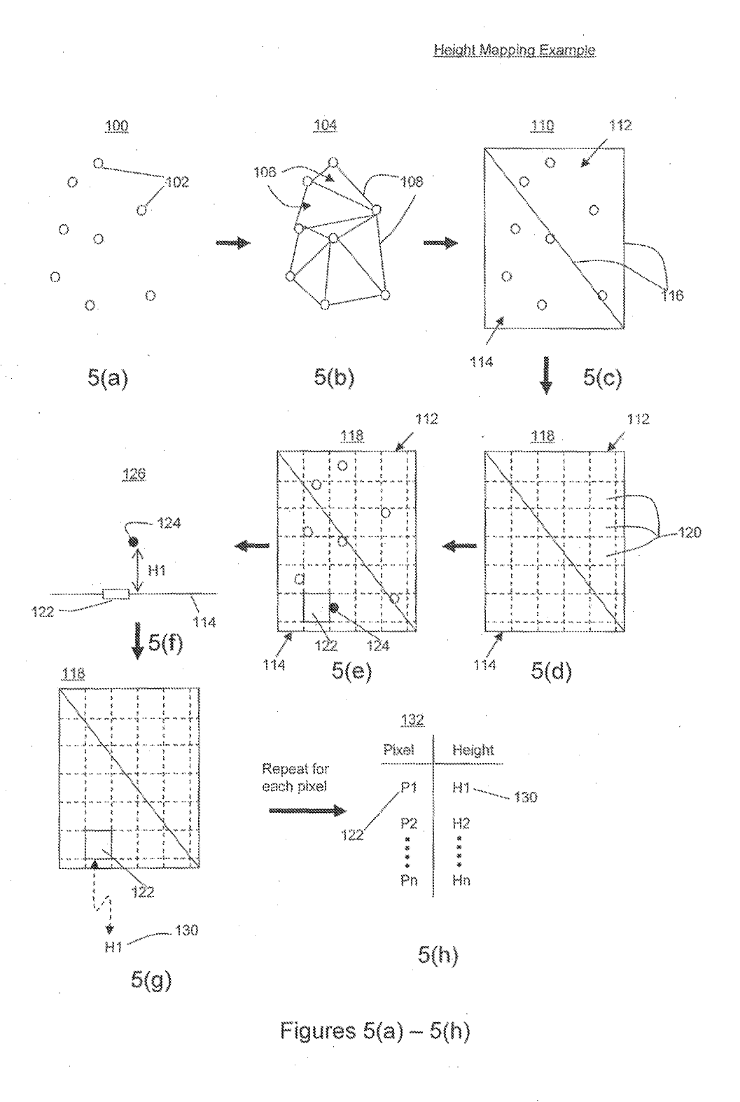

In another aspect, turning to FIGS. 5(a) to 5(h), a schematic diagram is shown in relation to the operations of module 46 for generating height maps. Height mapping or bump mapping associates height information with each pixel in an image. Module 46 allows for point cloud data (e.g. 3D data) to be displayed on a two-dimensional screen of pixels, while maintaining depth information. The approach is also suited for computing devices with limited computing resources.

Different stages or operations are shown in FIGS. 5(a) to 5(h). In FIG. 5(a), at an initial stage, a point cloud 100 is provided. The point cloud 100 is made of many data points 102, each having spatial coordinates, as well as other data attributes (e.g. RGB data, intensity data, etc.). At FIG. 5(b), a dense polygonal representation 104 is formed from the point cloud 100. The dense polygonal representation 104 is usually formed from many polygons 106, comprising edges or lines 108. At this stage, the data size of the polygonal representation 104 is typically still large.

At FIG. 5(c), a reduced polygon structure 110 is shown. The number of polygons from the polygonal representation 104 has been reduced, in this example, to two polygons 112 and 114. As can be seen, the number of lines or edges 116 defining the polygons has also been reduced. It is noted that a reduced number of polygons also reduces the data size, which allows the reduced polygonal structure 110 to be more readily transmitted or displayed, or both, to other computing devices (e.g. mobile devices). At FIG. 5(d), an image 118 is shown comprising pixels 120, whereby the image 118 is of the reduced polygon structure 110 that includes the polygons 112 and 114. The pixels 120 are illustrated by the dotted lines. In other words, the polygons 112 and 114 are decomposed into a number of pixels 120, which can be displayed as an image 118. Non-limiting examples of image formats can include JPEG, TIFF, bitmap, Exif, RAW, GIF, vector formats, SVG, etc.

At FIG. 5(e), for each pixel in the image 118, the closest data point from the point cloud 100 is identified. For example, for pixel 122, the closest data point is point 124. Turning to FIG. 5(f), an elevation view 126 of the polygon 114 is shown. As discussed above, pixels represent portions of the polygons. The pixel 122 represents a portion of the polygon 114. The height of the closest data point 124, as measured from above the location of the pixel 122 on the surface of the polygon 114, is determined. In this example, the height is H1. Therefore, as shown in FIG. 5(g), the height value H1 (130) is associated with the pixel 122 in the image 118.

The above operations shown in FIGS. 5(e), 5(f) and 5(g) are repeated for each pixel in the image 118. In this way a height mapping or bump mapping 132, that associates a height value with a pixel, is generated.

The above operations allows an image of an object to include surface detail. For example, a point cloud of a building may be provided, whereby the building has protrusions (e.g. gargoyles, window ledges, pipes, etc.) that raised above the building's wall surface. The point cloud may have data points representing such protrusions. A dense polygonal representation may also reveal the shape of the protrusions. However, to reduce the data size, when the dense polygonal representation of the point cloud has been reduced, the building may appear to have a flat surface, in other words, a large polygon may represent one wall of the building, and the surface height detail is lost. Although this reduces the data size and image resolution, it is desirable to maintain the height detail. By implementing the above operations (e.g. determining a height value for each pixel in the image based on the point cloud data), the height detail for the protrusions can be maintained. Therefore, the polygon representing the wall of the building may appear flat, but still maintain surface height information from the height or bump mapping. Based on the height or bump mapping, the image can be rendered, for example, whereby pixels with lower height values are darker and pixels with higher height values are brighter. Therefore, window ledges on a building that protrude out from the wall surface would be represented with brighter pixels, and window recesses that are sunken within the wall surface would be represented with darker pixels. There are many other known visualization or image rendering methods for displaying pixels with height values which can be applied to the principles described herein.

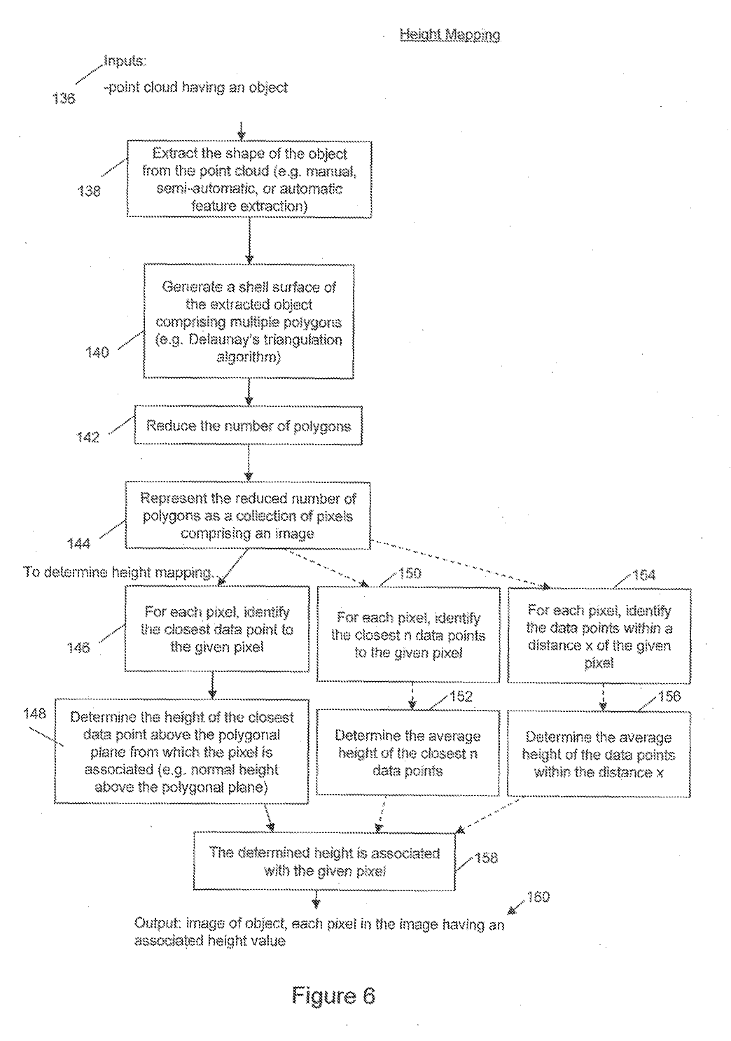

Turning to FIG. 6, example computer executable instructions are provided generating an image with each of the pixels having an associated height value. These instructions can be performed by module 46. The inputs 136 include at least a point cloud of an object. At block 138, the shape of the object is extracted from the point cloud. The shape or the features can be extracted manually, semi-automatically, or automatically.

At block 140, a shell surface of the extracted object is generated. The shell surface comprises is a dense polygon representation (e.g. comprises many polygons). The shell surface can, for example, be generated by applying Delaunay's triangulation algorithm. Other known methods for generating wire frames or 3D models are also applicable. At block 142, the number of polygons of the shell surface is reduced. The methods and tools for polygon reduction in the area of 3D modelling and computer aided design are known and can be used herein. It can be appreciated that polygonization (e.g. surface calculation of polygon meshes) are known. For example, an algorithm such as Marching Cubes may be used to create a polygonal representation of surfaces. These polygons may be further reduced through computing surface meshes with less polygons. An underlying ‘skeleton’ model representing underlying object structure (such as is used in video games) may also be employed to assist the polygonization process. Other examples polygonization include a convex hull algorithm for computing a triangulation of points from the voxel space. This will give a representation of the outer edges of the point volume. Upon establishing the polygons or meshes, the number of polygons can be reduced using known mesh simplification techniques (e.g. simplification using quadratic errors, simplification envelopes, parallel mesh simplification, distributed simplification, vertex collapse, edge collapse, etc.). A reduction in polygons decreases the level of detail, as well as the data size, which is suitable for devices with limited computing resources.

At block 144, the reduced number of polygons are represented as a collection of pixels that compose an image. In one embodiment, at block 146, for each pixel, the closest data point to the given pixel is identified. At block 148, the height of the closest data point above the polygonal plane with which the pixel is associated is determined. The height may be measured as the distance normal (e.g. perpendicular) to the polygonal plane.

In another embodiment, at block 150, for each pixel, the closest n data points to the given pixel are identified. Then, at block 152, the average height of the closest n data points measured above the polygonal plane(s) is determined.

In another embodiment, at block 154, for each pixel in the image, the data points within distance or range x of the given pixel are identified. Then, at block 156, the average height of the data points (within the distance x) is determined.

It can be appreciated that there are various ways of calculating the height attribute that is to be associated with a pixel. The determined height is then associated with the given pixel (block 158). From the process, the output 160 of the image of the object is generated, whereby each pixel in the image has an associated height value.

A similar process can be applied to map other attributes of the data points in the point cloud. For example, in addition to mapping the height of a point above a surface, other attributes, such as color, intensity, the number of reflections, etc., can also be associated with pixels in an image.

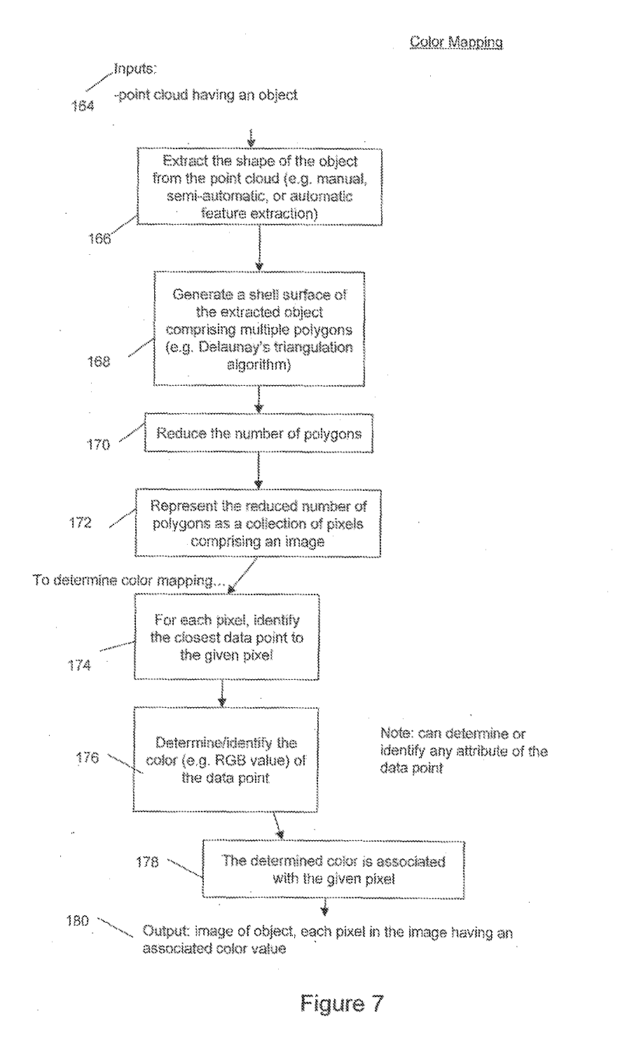

Turning to FIG. 7, example computer executable instructions are provided for generating a color map. Such instructions can be implemented by module 48. The input 164 at least includes a point cloud representing one more objects. Each data point in the point cloud is also associated with a color value (e.g. RGB value). At block 166, the computing device 20 extracts the shape of the objects from the point cloud (e.g. either manually, semi-automatically, or automatically). At block 168, a shell surface or 3D model of the extracted object is generated, comprising a dense polygon representation. At block 170, polygon reduction is applied to the dense polygon representation, thereby reducing the number of polygons. At block 172, the model or shell of the object, having a reduced number of polygons, is represented as a collection of pixels comprising an image.

At block 174, for each pixel, the closest data point to the given pixel is identified. At block 176, the color value (e.g. the RGB value) of the closest data point is identified and then associated with the given pixel (block 178). The output 180 from the process is an image of the object, whereby each pixel in the image is associated with a color value (e.g. RGB value).

It is appreciated that the images with height mapping or color mapping, or both, can be compressed using known wavelet-based compression methods to allow for multi-resolution extraction of the data. Other compression methods may support multi-resolution extraction of the data.

The compressed image files can be reconstructed. At a first stage, different types data is gathered. In particular, the compressed image files for the height maps and the surface color maps, the approximate model which references these maps, as well as possible surface classification parameters are transmitted to the rendering module or processor (not shown).

At a second stage, based on the view distance and angle (e.g. zoom views, side view, etc.), the images are extracted to an appropriate resolution. This, for example, is done using wavelet-based extraction. This extraction can change as the view zooms to maintain visually appealing detail.

At a third stage, the height maps, color maps, and/or parametric surface material textures are passed to a pixel shader based rendering algorithm through use of texture memory. A pixel shader can be considered a software application that can operate on individual pixels of an image in a parallel manner, through a graphics processing unit, to produce rendering effects. Texture memory is considered dedicated fast access memory for a GPU to use. In other words, the pixel shader, using the texture memory, is able to store data in high speed memory and use a special pixel-processing program to render the building model to provide detail that is visible to the eye.

At a fourth stage, the per-pixel light-based height map and RGB texturing is used to render the approximate model. User interaction or inputs may provide height information based on reversing texture interpolation to recover texel values (e.g. values of textured pixels or textured element) from height map for precision measurement, or to provide haptic feedback of surface texture. Such compression and decompression as described above can be used to generate real-time rendering of the images. In one embodiment, real-time rendering can be performed in the GPU by setting up the parameters for geometry transformation and then invoking the rendering commands (e.g. such as for the pixel shader).

The height mapping and the color mapping can also be applied to determine or classify the materials of objects. Generally, based on the color of a surface, the height or texture of surface, and the type of object, the type of material can be determined. For example, if the object is known to be a wall that is red and bumpy, then it can be inferred or classified that the wall material is brick.

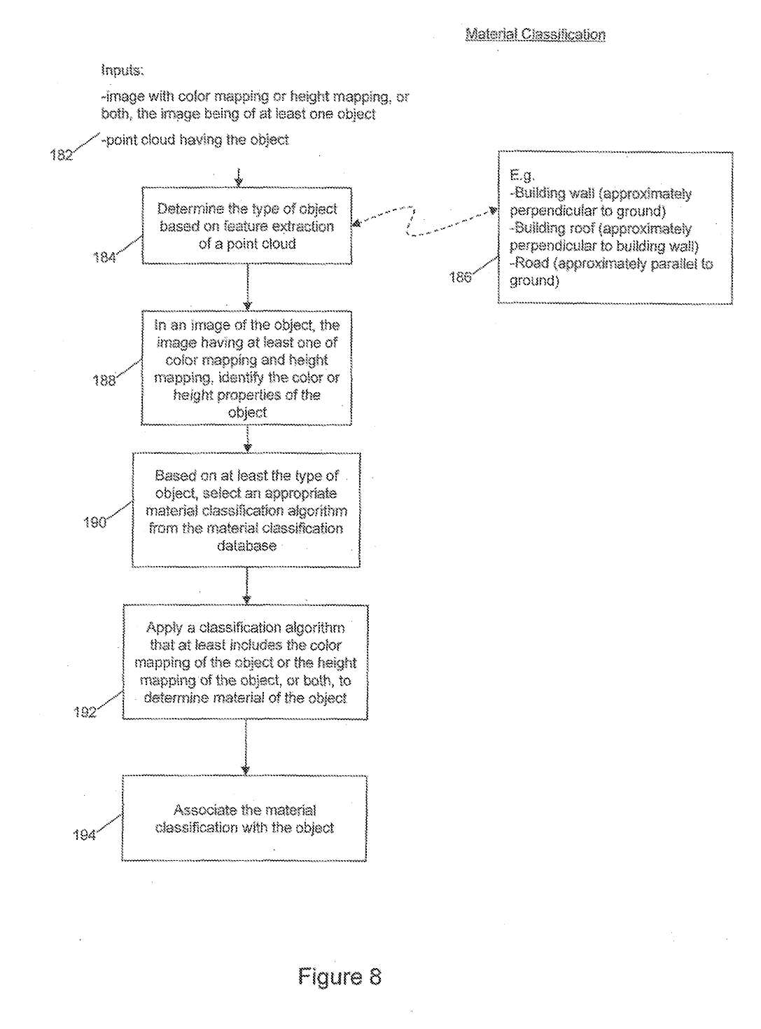

Turning to FIG. 8, example computer executable instructions are provided for classifying material. These instructions may be implemented by module 50. The inputs 182 include an image with at least one of color mapping or height mapping, whereby the image is of an object, and a point cloud representing at least the object. At block 184, the computing device 20 determines the type of object based on feature extraction of the point cloud. The type of object may be categorized in the objects database 521. Examples of object types, as well has how they are determined, are provided at block 186. In particular, an object, such as a building wall, is identified if the structure is approximately perpendicular to the ground. In another example, a building roof can be identified if it is approximately perpendicular to a building wall, or is at the top of a building structure. A road can be identified by a dark color that is at ground level. It can be appreciated that the examples provided at block 186 are non-limiting and that there many other methods for identifying and categorizing types of objects.

At block 188, in the image of the object, the height properties (e.g. if there is a height or bump mapping) or the color properties (e.g. if there is a color mapping), or both, are identified for the object. In other words, it is determined if there are there any bumps or depressions in the object, or what the color patterns are on the object. At block 190, based on at least the type of object, the computing device 20 selects an appropriate material classification algorithm from a material classification database (not shown). The material classification database contains different classification algorithms, some of which are more suited for certain types of objects. At block 192, the selected classification algorithm is applied. The classification algorithm takes into account the color mapping or height mapping, or both, to determine the material of the object. At block 194, the determined material classification is associated with the object.

In general, it is recognized that the color mapping, or height mapping, or both can be used to classify the material of the object. Further, once the material is classified (e.g. brick material for a wall surface), then the object can be displayed having that material.

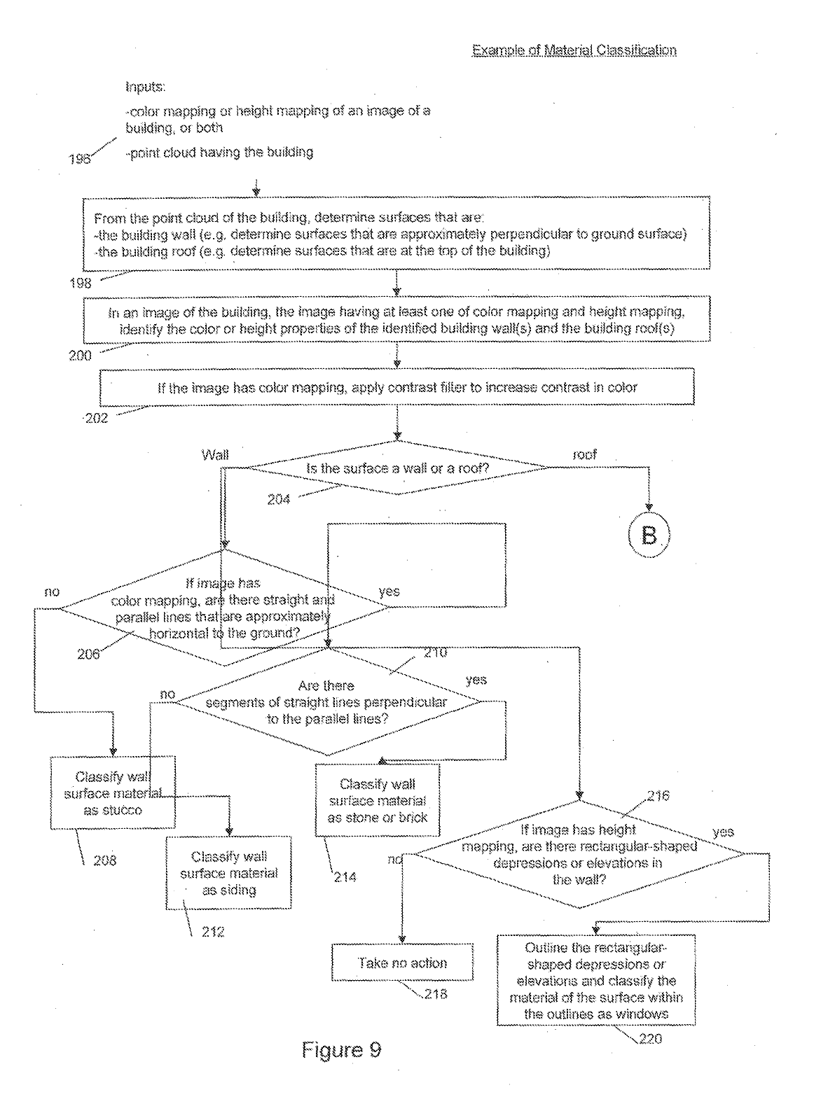

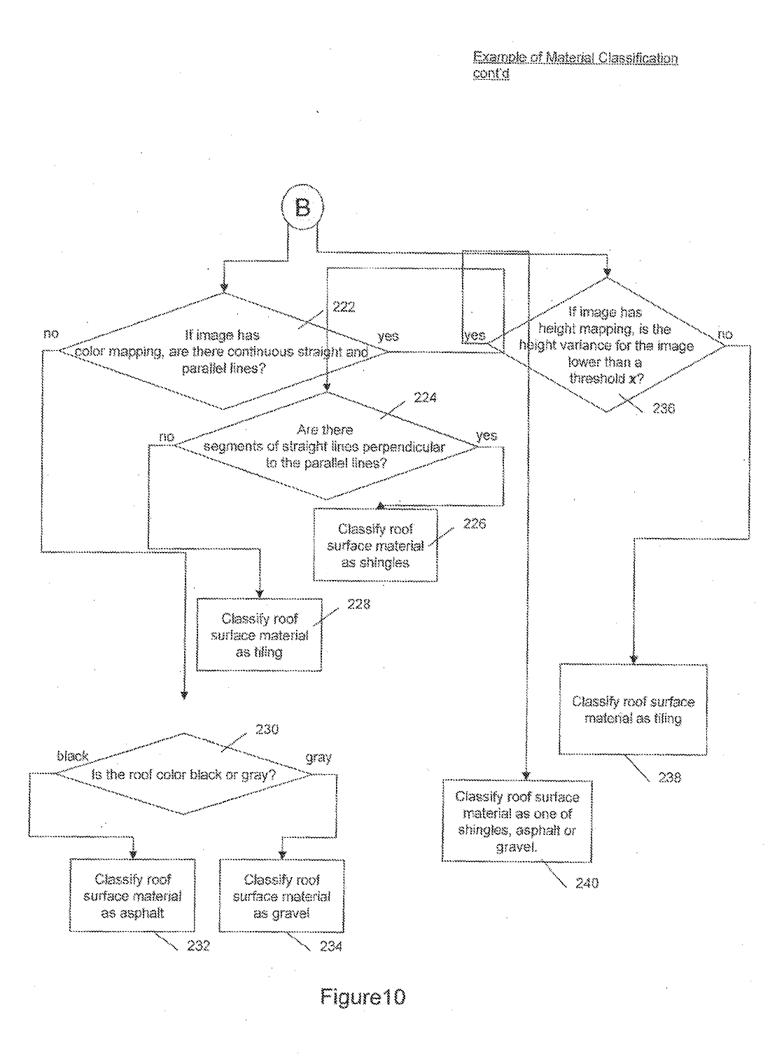

An example of material classification for wall and roof surfaces is provided in FIGS. 9 and 10. Turning to FIG. 9, example computer executable instructions are provided for classifying the material of a building using color mapping or height mapping, or both. The input 196 includes at least one of a color map or a height map, or both, of an image of a building. The input 196 also includes a point cloud having the building. At block 198, from the point cloud of the building, the building wall surfaces are identified and the building roof surfaces are identified. The wall surface are those that are approximately perpendicular to the ground, and the building roof surfaces are those that are at the top of the building. At block 200, in the image of the building, if the color mapping is available, then the color of the identified wall(s) or roof(s) are extracted. If the height mapping is available, then the height or texture properties of the building wall(s) and roof(s) are extracted. At block 202, if the image has color mapping, then a contrast filter may be applied to increase the contrast in any color patterns. For example, in a brick pattern, increasing the contrast in the color would highlight or make more evident the grouting between the bricks.

At block 204, it is determined if the surface is a wall or a roof. If the surface is a wall, then at block 206, if the image has color mapping, then it is determined whether there are straight and parallel lines that are approximately horizontal to the ground. If not, at block 208, then the wall surface material is classified as stucco. If there are straight and parallel line, then at block 210, it is determined if there are segments of straight lines that are perpendicular to the parallel lines. If not, in other words there are only straight parallel lines on the wall, then the wall surface material is classified as siding (block 212). If there are segments of straight and perpendicular lines, then at block 214, the wall surface is classified as stone or brick material.

In addition, or in the alternative, if the image has height mapping as well, then at block 216 it is determined if there are rectangular-shaped depressions or elevations in the wall. If not, no action is taken (block 218). However, if so, then at block 220, the rectangular-shaped depressions or elevations are outlined, and the material of the surface within the outlines are classified as windows.

If, from block 204, the surface of the object relates to a roof, then the process continues to FIG. 10. This is indicated by circle B, shown in both FIGS. 9 and 10.

Continuing with FIG. 10, if the image has color mapping, then at block 222, it is determined whether there are straight and parallel lines? If not, then it is determined if the roof color is black or gray (block 230). If it is black, then the roof material is classified as asphalt (block 232), while if it is gray, then the roof material is classified as gravel (block 234).

If there are straight and parallel lines, at block 224, it is determined if there are segments of straight lines that are perpendicular to the parallel lines. If not, at block 228, the roof surface material is classified as tiling. If there are straight and perpendicular line segments, then the roof material is classified as shingles (block 226).

In addition, or in the alternative, if the image has a height or bump mapping, then at block 236 it is determined if the height variance fir the image is lower then a given threshold x. If the height variance for the roofing surface is below x, then the roof surface is classified as one of shingles, asphalt or gravel (block 238). Otherwise, the roof surface is classified as tiling (block 238).

The above algorithms are examples only, and other variations, alternatives, additions, etc. for classifying materials based on color mapping or height mapping, or both, are applicable to the principles described herein.

Other example classification methodologies include using of parameters of geometry. As discussed above, the angle of geometry of an object relative to a ground surface can be used to determine the type of object and furthermore, the type of material. Objects on the same plane as a ground (e.g. a road) can be determined based on known parameters (e.g. feature extraction). The object's recognized features can also be compared with known materials.

Other classification approaches include using color patents or image patterns from the image. In particular, regular patterns (e.g. bricks, wood) can be identified based on a set of pixels and a known set of possibilities. Road stripes and airfield markings can also be identified based on their pattern. A window can be identified based on reflections and their contrast. Lights can also be identified by their contrast to surroundings. Crops, land coverings, and bodies of water can be identified by color.

Occluded information can also be synthesized or reproduced using classification techniques, based on the height mapping and color mapping. For example, when an environment containing a wall and a tree (in front of the wall) is interrogated using LIDAR from only one angle, a 2D image may give the perception that the tree is pasted on the wall. In other words, the tree may appear to be a picture on a wall, rather than an object in front of the wall. An image with a height mapping would readily show that the tree is considered a protrusion relative to the wall surface. Therefore, if it is desired that only the wall is to be displayed, then any protrusions relative to the wall surface (based on the height mapping) can be removed. Removal of the tree also produces visual artifacts, whereby the absence of the tree produces a void (e.g. no data) in the image of the wall. This void can be synthesized by applying the same color pattern as the wall's color mapping. Alternatively, if the wall has been given a certain material classification, and if a known pattern is associated with the given material classification, then the known pattern can be used to “fill” the void. Naturally, the pattern would be scaled to correspond with the proportions of the wall, when filling the void. These approaches for artifacts can also be applied for top-down views of cars on a roof.

Other classification methods can use different inputs, such as the signal strength of return associated with points in a point cloud, and IR or other imagery spectrums.

The applications for the above classification methods include allowing the detailed display of objects without the need for a detailed RBG of bump map for an approximate model. The surfaces of the object could be more easily displayed by draping the surfaces with the patterns and textures that are correspond to the object's materials. For example, instead of showing a brick wall composed of a height mapping and a color mapping, a brick pattern can be laid over the wall surface to show the similar effect. This would involve: encoding surfaces with a material classification code; potentially encoding a color (or transparency or opaqueness level) so the surface can be accurately rendered; and encoding parametric information (such as a scale or frequency of a brick pattern or road markings).

The rendering process can use classification information to create more realistic renderings of the objects. For example, lighting can be varied based on modeling the material's interaction with lighting in a pixel shader. Material classification can also be used in conjunction with haptic effects for a touch UI. Material classification can also be used for 3D search parameters, estimation, emergency response, etc. Material classification can also be used to predict what sensor images of a feature might look like. This can be used for active surveillance, real time sensor 3D search, etc.

In another aspect of the systems and methods described herein, the display of the data is interactive. A user, for example, may want to view a 3D model of one or more objects from different perspectives. The user may also want to extract different types of information from the model. The amount and variety of spatial data is available, as can be understood from above. However, displaying the data in a convenient and interactive approach can be difficult. The difficulties of relaying the spatial data to a user are also recognized when displaying data on a 2D display screen, or a computing device with limited computing resources (e.g. mobile devices). Typically, user interface systems that are natively designed for 2D screens are not suitable for the display of rich spatial data

A 3D UI is provided to address some these difficulties. A 3D UI is a user interface that can present objects using a 3D or perspective view. UI objects include typically three categories. In a first category, there are items intended for ‘control’ of the computer application, such as push buttons, menus, drag regions, etc. In a second category, there are items intended for data display, such as readouts, plots, dynamic moving objects, etc. In a third category, there are 3D items, typically objects representing a 3D rendering of a model or other object. The 3D models or objects, as described earlier, may be generated or extracted from point cloud data that, for example, has been gathered through LiDAR.

A 3D UI is composed of 3D objects and provides a user interface to a computer application. 3D objects or models do not need to necessarily look 3D to a user. In other words, 3D objects may look 2D, since they are typically displayed on a 2D screen. However, whether the resulting images (of the 3D objects) are 2D or 3D, the generating of the images involves the use of 3D rendering for display.

In one aspect, a 3D UI system is provided to allow haptic feedback (e.g. tactile or force feedback) to be integrated with the display of 3D objects. This allows 3D spatial information, including depth, to be a part of the user experience. In another aspect, a 3D UI is provided for mapping typical 2D widget constructs into a 3D system, allowing more powerful UIs to be constructed and used in a natively 3D environment. For example, 2D widgets (e.g. a drop box, a clipped edit window, etc.) can be displayed on 2D planes in a 3D scene. In another aspect, the 3D UI allows ‘smart’ 3D models that contain interactive elements. For example, a 3D building model can be displayed and have encoded within interactive UI widgets. The UI widgets allow a user to manipulate or extract information from the building model. The 3D UI can operate in various environments, such as different classes of OpenGL based devices. OpenGL Web clients, etc.

In another aspect, the above 3D UI approaches may be integrated into a software library to manage the creation and display of these functions. Thus, the 3D UIs may be more easily displayed on different types of devices. The above 3D UI approaches also enable future applications on less typical displays, such as head mounted displays, 3D projectors, or other future display technologies.

In yet another aspect, the 3D UI provides navigation tools allowing the point of view of a 3D model to be manipulated relative to points or objects of interest.

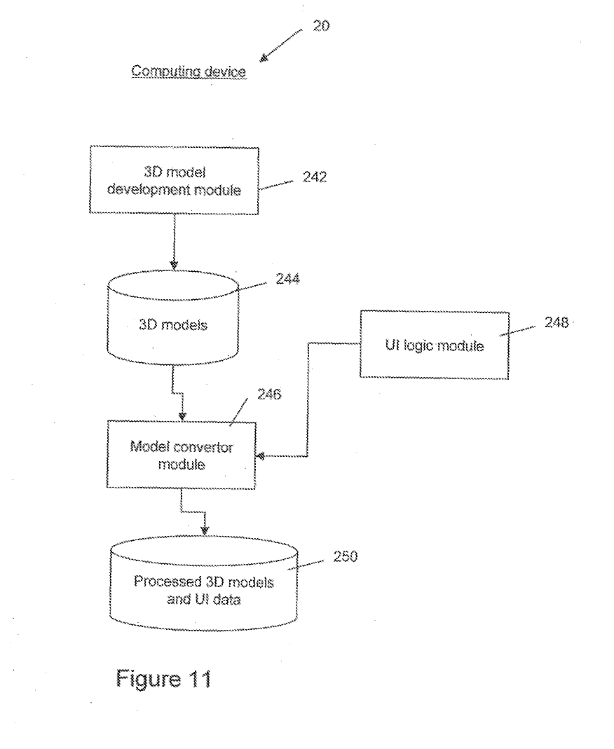

Turning to FIG. 11, an example configuration of the computing device 20, suitable for generating 3D models and 3D user interfaces, is provided. Such a configuration can be part of, or combined with, the computing device 20 shown in FIG. 2. The configuration includes a 3D model development module 242. This can be a typical 3D modeling tool (e.g. CAD software), or can perform automated feature extraction methods capable of generating 3D models. As described earlier, the 3D models may be generated from point cloud data, or from other data sources. The 3D models are stored in a 3D models database 244. The models from the database 244 are obtained by the model convertor module 246. The model convertor module 246 generates 3D model data (e.g. spatial data) and the UI logic that is mapped on to or corresponding with the specified 3D model data. In particular, the convertor module 246 combines 3D models from the 3D models database 244 with UI logic, generated by the UI logic module 248. The UI logic module includes computer executable instructions related to the creation of widgets from 3D objects, the binding of haptic effects to 3D content, and the specification of feedback action (e.g. show, hide, fade, tactile response, etc.) based on inputs, such as clicking, touch screen inputs, etc.

Based on the above, the outputs from the model convertor module 246 include geometric objects (e.g. definitions, instances (copies)); logic objects related to the dynamic display of data, interactive display panels, and haptics; and texture objects. These outputs may be stored in the processed 3D models and UI database 250.

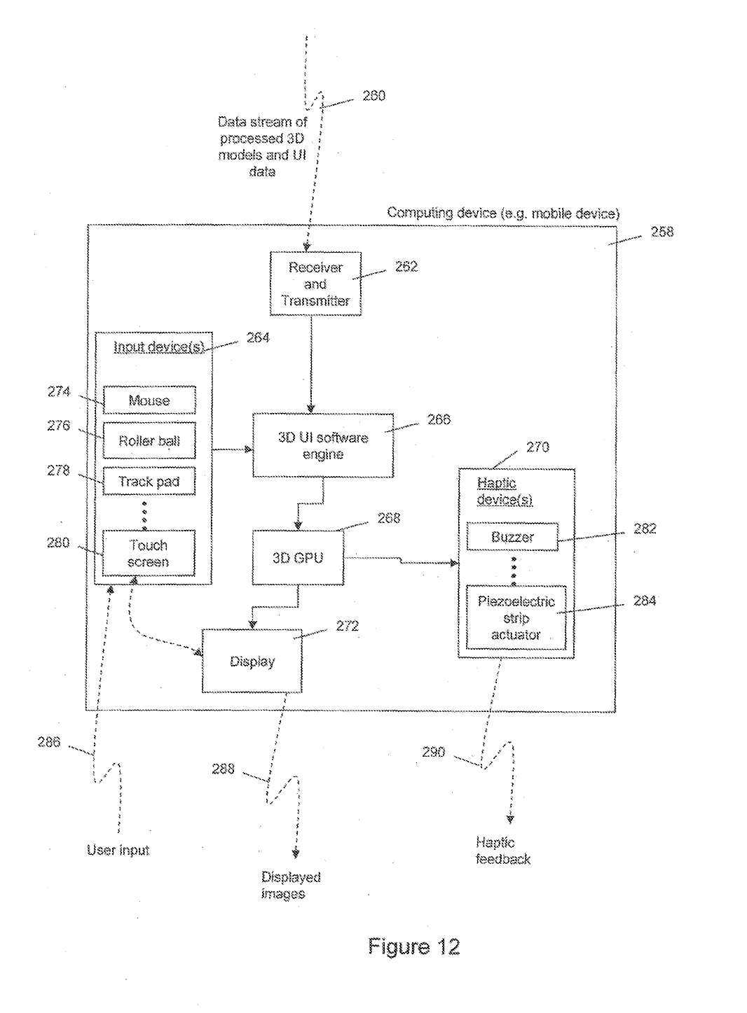

Turning to FIG. 12, an example configuration of a computing device 258, suitable for providing haptic responses, is provided. The computing device 258 may be different from the computing device 20 described above, or it may be the same device. In a typical embodiment, however, the computing device 258 may be a mobile device (e.g. smart phone, PDA, cell phone, pager, mobile phone, lap top, etc.). In one example, the mobile device 258 may have significantly limited computing resources compared to the other computing device 20. Therefore, it may be desirable to dedicate computing device 20 for performing more intensive computer operations in order to reduce the computing load on the computing device 258. It can be appreciated that in many mobile applications, many of the computations can occur on a server or computing device, with only the results being sent to the mobile device.

Continuing with FIG. 12, the computing device 258 (if separate from computing device 20, although not necessarily) includes a receiver and transmitter 262 for receiving data from the other computing device 20. The receiver and transmitter 262 or transceiver is typical, for example, in mobile devices. The received data comes from the database 250 and generally includes processed 3D models and associated UI data. This data is combined with input data from the input device(s) 264, by the 3D UI software engine 266. The 3D UI software engine 266 then determines the appropriate visual response or haptic response, or both, for the interface. The interface feedback is then processed by the 3D graphics processing unit (GPU) 268, which, if necessary, modifies the displayed images 288 shown on the computing device's display 272. The 3D GPU 268 may also activate a haptic response or generate haptic feedback 290 through one or more haptic devices 270.

As can be seen from FIG. 12, the computing device 258 can receive different types of user input 286, depending on the type of input device 264 being used. Non-limiting examples include using a mouse 274 to move a pointer or cursor across a display screen (e.g. across display 272). Similar devices for moving a pointer or cursor include a roller ball 275, a track pad 278, or a touch screen 280. It can be appreciated that the computing device 258 may be a mobile device and that mobile devices such as, for example, those produced by Apple™ and Research In Motion™ typically include one or more of such input devices. The computing device 258 may also includes one or more haptic devices 270, which generate tactile or force feedback, also referred to as haptic feedback or response 290. Non-limiting examples of haptic devices 270 are a buzzer 282 or piezoelectric strip actuator 284. Other haptic devices can also be used. An example haptic system that can be used to interface the 3D GPU 268 is TouchSense™ from Immersion Technology.

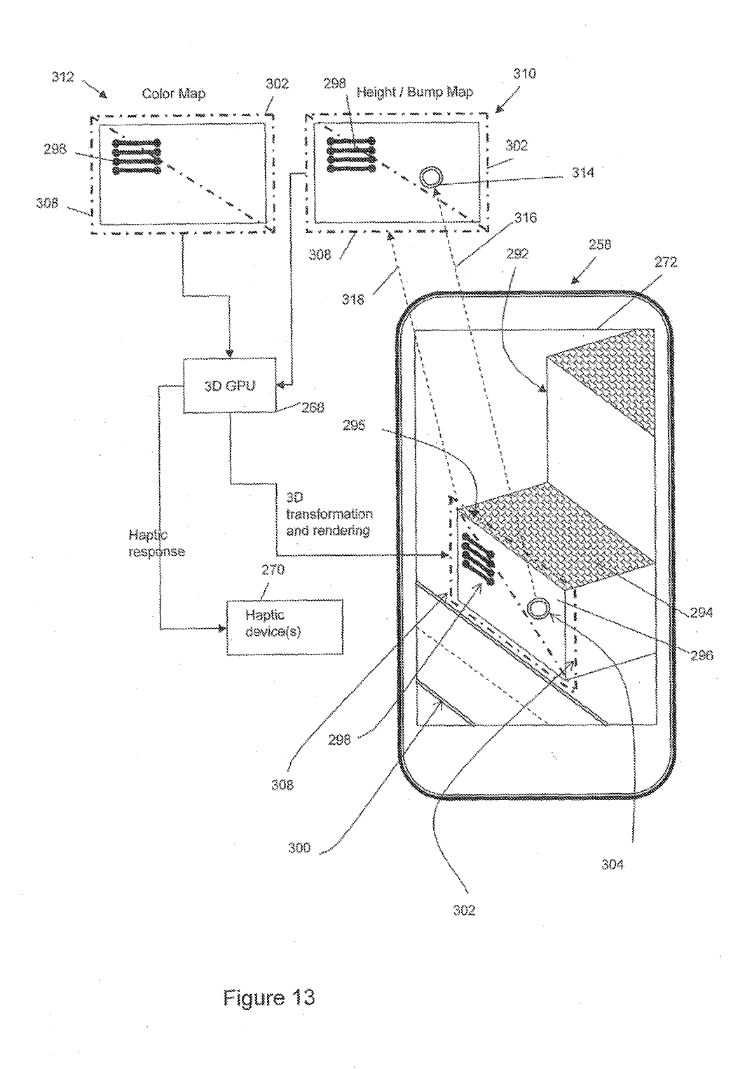

Turning to FIG. 13, an example of a computing device 258 is shown in the context of generating a haptic response based on where a user places a pointer 304 on the display 272. A pointer can mean any cursor or indicator that is used to show the position on a computer monitor or other display device (e.g. display 272) and that will respond to input from a text input or a pointing device (e.g. mouse 274, roller ball 276, track pad 278, touch screen 280, etc.). In the example of FIG. 13, the computing device 258 is mobile device with a touch screen 208 surface. In other words, the user can control the pointer 304 (illustrated as two concentric circles) by touching the display 272.

The display 272 shows an image of a budding 292 beside a road 300. It can be appreciated that the image of the building 292 and road 300 are generated or derived from 3D model of point cloud data. In other words, the three dimensional shape of the building 292 and the road 300 are known. The building 292 includes a roof 294, which in this case is tiled. Adjacent to the roof 294 is one of the building's walls 296. Located on the wall 296 are several protruding vents 298. As described earlier with respect to FIGS. 5 and 6, there may be a 3D model of the building 292 represented by polygonal surfaces. Preferably, although not necessarily, polygon reduction is applied to the model to reduce the number of polygon surfaces. In FIG. 13, the wall 296 corresponds to a polygon reduced model 302 comprising two triangle surfaces. The pointer 304 is positioned on the wall 396, in an area of one of the triangles (e.g. polygon surfaces). In the other triangle of the polygon model 302, there are protruding vents 298.

Based on the position of the pointer 304 on the display 272, a haptic response is accordingly produced. In particular, the position of the pointer 304 on the display 272, represents a position on the image of the building 292 being displayed. The position on the image of the building 292 corresponds with a position on the surface of the 3D model of the building 292. Therefore, as the pointer moves across the display 272, it is also considered to be moving along the surface of a 3D model of the building 292.

It can be appreciated that the 3D UI software engine module 266 coordinates the user input for pointing or directing the position of the pointer 304 with the 3D GPU module 268. Then, the 3D GPU integrates the 3D model of the building 292, the position of the pointer 304, and the appropriate haptic response 290. The result is that the user can “feel” the features of the building 292, such as the corners, edges, and textured surfaces through the haptic response 290.

Continuing with FIG. 13, if, for example, the pointer 304 moves across the display 272 (e.g. in 2D) towards the protruding vents 298, based on the current perspective viewpoint of the building 292 on the display 272, then the pointer 304 would be considered moving further “into” the screen in 3D. In other words, the depth of the wall 296 (e.g. how one side of the wall is closer and another is further) is being captured by the 3D model of the building 296. Based on the depth of the pointer 304, the haptic response may be adjusted. From the perspective viewpoint, some of the pixels representing the wall 296 on the display 272 would be considered closer, while other pixels would be considered further away. For example, the further the pointer 304 moves “into” the screen (e.g. away from the perspective viewpoint), the lower the magnitude of the haptic response. Conversely, in order to generate a “feel” that the wall 296 is getting closer, when the pointer 304 moves along the wall 296 closer towards the perspective viewpoint, then the magnitude of the haptic response will correspondingly increase. As discussed earlier, the haptic response can be a buzzing or vibrating type tactile feedback.

In another example, if the position or location of the pointer 304 on the display 272 were to move from the wall 296 to the adjacent roof 294, then the pointer 304 would consequently be crossing over the roof's edge defined by the wall 296 and roof 294. The edge would also be represented in the 3D model of the building 292 and would be defined by the surface of the wall 296 in one plane and the surface of the roof 294 in another plane (e.g. in a plane perpendicular to the wall's plane). The pixels on the display 272 representing the edge would then be associated with a haptic response, so that when the pointer 304 moves over the edge, the 3D GPU would detect the edge and provide a haptic response. In an example embodiment, the haptic response would be a short and intense vibration to tactilely represent the sudden orientation of the planes between the wall 296 and the roof 294.

In another example, the material or texture classification (e.g. based on color mapping and height mapping), and the height mapping that are associated with a polygon surface on the building model, can also be tactilely represented. When the pointer 304 moves over a bumpy surface, then the device 258 will provide a haptic response (e.g. intermittent vibrations).

In a specific example shown in FIG. 13, the wall 296 is represented by the polygon model 302 comprising two triangles (e.g. polygons). Associated with the polygon model 302 is a height map or bump map 310 of the wall 296 and a color map 312 of the wall 296. The wall surface, according to the height map 310, is flat. Therefore, as the pointer 304 moves across the wall, there is no or little haptic response based on the surface texture. However, the protruding vents 298 are considered to be raised over the wall's surface, as identified by the height map 310. In other words, the pixels on the display 272 that represent or illustrate the raised surfaces or bumps, are associated with a haptic response. For example, the vents 298 in the height map 310 are considered to have raised height values. Therefore, the pixels representing the vents 298 are associated with raised surfaces, and are also associated with a haptic response. Consequently, when the pointer 304 moves over the pixels representing the vents 298, the device 258 generates a haptic response, e.g. intermittent vibrations. In this way, a user can feel the bumps of the vents 298 protruding from the wall 296 on the display 272.

In another example, also shown in FIG. 13, the color mapping can be used. A color mapping of the roof 294 would reveal a patterned image. A material classification scheme (e.g. FIGS. 9 and 10) could be applied to identify the roof 294 as a collection of tiles. Based on the roof surface material being classified as tiles, a texture surface with corresponding haptic response can be assigned to the roof 294. Since a tiled roof is considered to be a “bumpy” surface, the pixels representing the roof 294 are associated with a haptic response. Therefore, when the pointer 304 moves over the pixels representing the roof 294, then the computing device 258 will provide haptic responses via the one or more haptic devices 270. An example haptic response is a buzzer vibrating intermittently to synthesize the bumpy feel of the tiled roof 294.

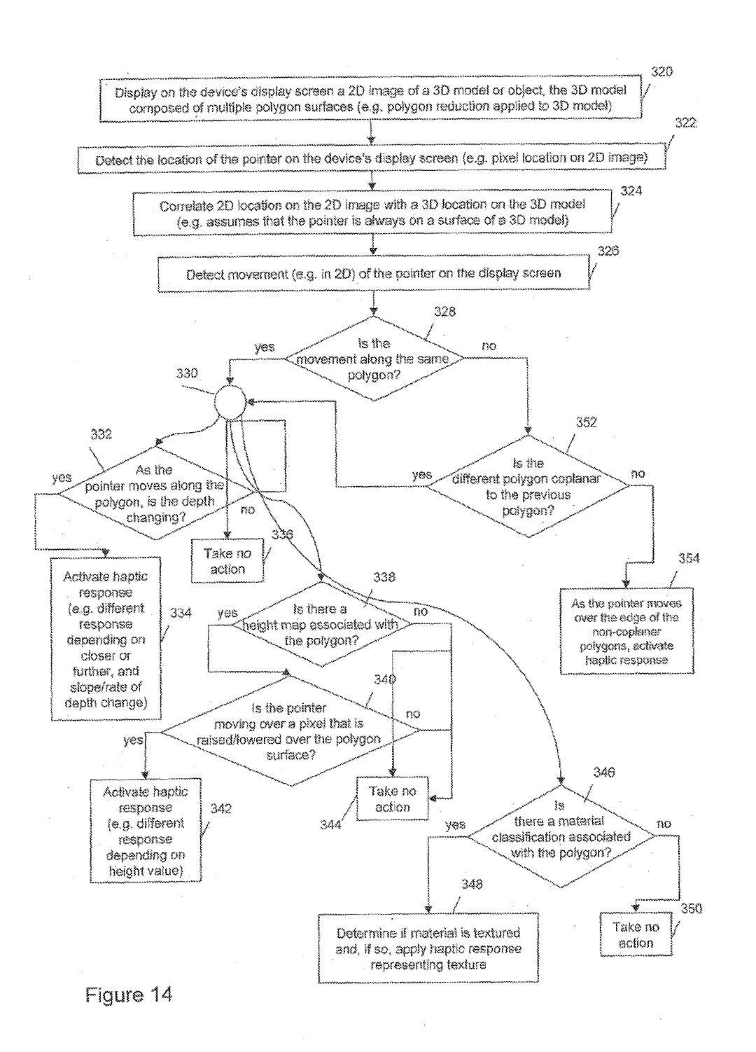

FIG. 14 provides example computer executable instructions for generating a haptic response based on movement of a pointer 304 across a display screen 272. Such instructions may be implemented by module 52. It will be appreciated that module 52 can reside on either the computing device 20 or the other computing device 258, or both. At block 320, the computing device 258 display on the screen 272 a 2D image of a 3D model or object, whereby the 3D model is composed of multiple polygon surfaces. Polygon reduction is preferably, although not necessarily, applied to the 3D model. At block 322, the location of the pointer 304 on the device's display screen 272 is detected (e.g. the pixel location of the pointer 304 on the 2D image is determined). At block 324, the 2D location on the 2D image is correlated with a 3D location on the 3D model. This operation assumes that the pointer is always on a surface of a 3D model. At block 326, the movement (e.g. in 2D) of the pointer 304 is detected on the display screen 272.

Continuing with FIG. 14, it is determined if the movement of the pointer 304 is along the same polygon (block 328) then the process continues to node 330. From node 330, several processes can be initialized, either serially or simultaneously. In other words, blocks 332, 338 and 346 are not mutually exclusive.

At block 332, that is if the pointer 304 moves along the same polygon, it is further determined if the position of the pointer 304 in the 3D model changes in depth. In other words, it is determined if the pointer 304 is moving further away or closer from the perspective point of view of the 3D model as shown on the display 272. If so, at block 334, a haptic response is activated. The haptic response may vary depending on whether the pointer 304 is moving closer or further, and at what rate the depth is changing. If the depth is not changing along the polygon, the no action is taken (block 336).

At block 338, it is determined if there is a height map associated with the polygon. If not, not action is taken (block 344). If so, it is then determined if the pointer 304 is moving over a pixel that is raised or lowered relative to the polygon surface. If it is detected that the pointer 304 is moving over such a pixel, then a haptic response is activated (block 342). The haptic response can vary depending on the height value of the pixel. If no height value or difference is detected, then no action is taken (block 344).

If the movement of the pointer 304 is moving along the same, or within the same, polygon, then the computing device 258 may also determine if there is a material classification associated with the polygon (block 346). If so, at block 348, if it is detected that the material is textured, then a haptic response is generated. The haptic response would be represent the texture of the material. If there is not material classification, no action is taken (block 350).

Continuing with FIG. 14, if at block 328 the movement of the pointer 304 is not along the same polygon (e.g. the pointer moves from one polygon to a different polygon), then it is determined if the different polygon is coplanar with the previous polygon (block 352). If so, then the process continues to node 330. However, if the polygons are not coplanar, then as the pointer 304 moves over the edge defined by the non-coplanar polygons, then a haptic response is activated (block 354). In one example, the greater the difference in the angle between the planes of the polygons, the more forceful the haptic response. This can be applied to edges of polygons between a wall and a roof, as discussed earlier with respect to FIG. 13.

In another aspect of the user interface, traditional two-dimensional planes may be displayed as windows in a 3D environment. This operation is generally referred to as windowing, which enables a computer to display several programs at the same time each running its own “window”. Typically, although not necessarily, the window is a rectangular area of the screen where data or information is displayed in 2D. Furthermore, in a window, the data or information is displayed within the boundary of the window but not outside (e.g. also called clipping). Further data or information in a window is occluded by other windows that are on top of them, for example when overlapping windows according to the Z-order (e.g. the order of objects along the z axis). Data or information within a window can also be resized by zooming in or out of the window, while the window size is able to remain the same. In many cases, the data or information within the window is interactive to allow a user to interact with logical buttons or menus within the window. A well-known example of a windows system is Microsoft Windows™, which allows one or more windows to be shown. As described above, windows are considered to be a 2D representation of information. Therefore, displaying the 2D data in a 3D environment becomes difficult.

The desired effect is to present a 2D window so it visually appears on a 3D plane within a 3D scene or environment. A typical approach is to render the window content to a 2D pixel buffer, which is then used as a texture map within the Graphics Processing Unit (GPU) to present the window in a scene. In particular, the clipping of data or information is done through 2D rectangles in a pixel buffer. Further, the Z-order and the resizing of information or data in the window is also computed within the reference of a 2D pixel buffer. The interactive pointer location is also typically computed by projecting a 3D location onto the 2D pixel buffer. These typical approaches involving mapping 2D content as a texture map in 3D can slow down processing due to the number of operations, as well as limit other capabilities characteristic of 3D graphics. Use of a 2D pixel buffer is considered an indirect approach and requires more processing resources due to the additional frame buffer for rendering. This also requires ‘context switching’. In other words, the GPU has to interrupt its current 3D state to draw the 2D content and then switch back to the 3D state or context. Also the indirect approach requires more pixel processing because the pixels are filled once for 3D then another time when the textured surface is drawn.

By contrast, the present 3D user interface (UI) windowing mechanism, as described further below, directly renders the widgets from a 2D window into a 3D scene without the use of a 2D pixel buffer. The present 3D UI windowing mechanism uses the concept of a 3D scene graph, whereby each widget, although originally 2D, is considered a 3D object. Matrix transformations are used so the GPU interprets the 2D points or 2D widgets directly in a 3D context. This, for example, is similar to looking at a 2D business card from an oblique angle. Matrix commands are passed to the GPU to achieve the 3D rendering effect.

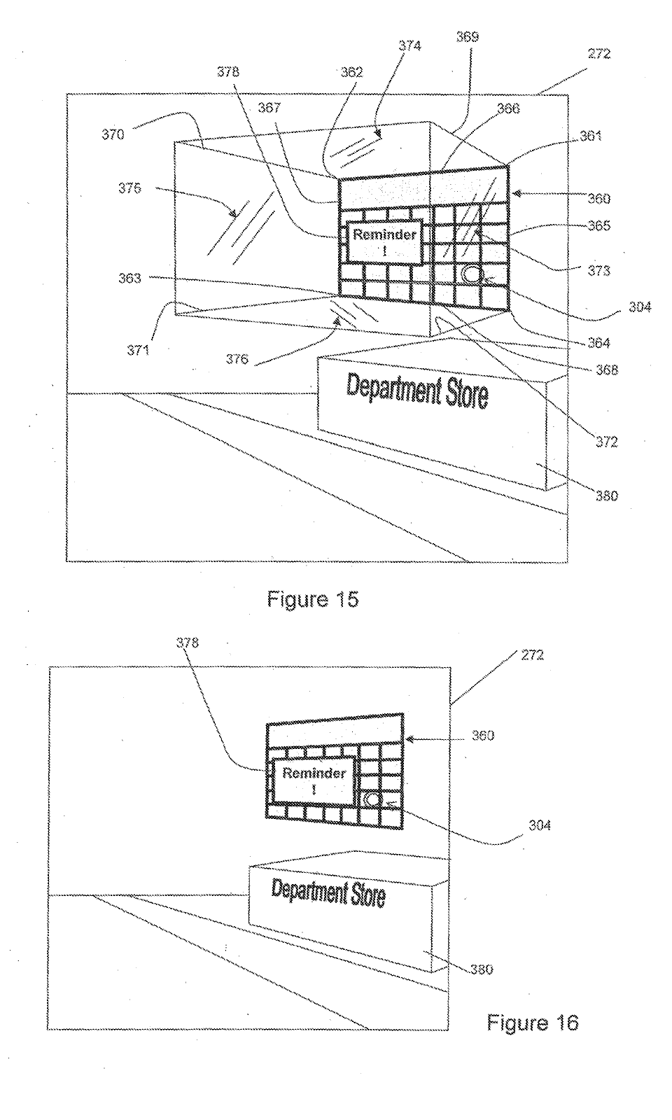

Turning to FIGS. 15 and 16, a display screen 272 is shown, for example using module 54. The display 272 is displaying a 3D scene of a department store building 380, a road, as well as a window 360 above the building 380. The window 360 can run an application, such as a calendar application shown here, or any other application (e.g. instant messaging, calculator, internet browser, advertisement, etc.). In the example application show, the window 360 shows a calendar of sales events related to the department store 380 and out-standing bill due dates for purchases made at the department store 380. A pop-up window 378 within the window 360 is also shown, for example, providing a reminder. The pointer or cursor 304 is represented by the circles and allows a user to interact with the window 360. It can be appreciated that FIG. 16 is the image shown to the user, while FIG. 15 includes additional components that are not shown to the user, but are helpful in determining how objects in the window 360 are displayed. As described above, the objects (e.g. buttons, calendar spaces, pop-up reminders, etc.) in the window 360 are considered 3D objects and are shown without the use of a 2D pixel buffer.

The window 360 is defined by a series of vertices 361, 362, 363, 364 that are used to define a plane. In this case, there are four vertices to represent the four corners of a rectangle or trapezoid. Lines 365, 366, 367, 368 connect the vertices 361, 362, 363, 364, whereby the lines 365, 366, 367, 368 define the boundary of the window 360. Four clipping planes 373, 374, 375, 376 are formed as a border to the window 360. The clipping planes 373, 374, 375, 376 protrude from the boundary lines 365, 366, 367, 368.

In particular, to form the clipping planes, at each vertex, the cross product of the boundary lines intersecting the corner are calculated to determine a normal vector. For example, at vertex 362, the cross product of the two vectors defined by lines 366 and 367 is computed to determine the normal vector 370. In a similar manner, the vectors 371, 372, and 369 are computed. These four vectors 369, 370, 371, 372 are normal to the plane of the window 360. A clipping plane, for example, clipping plane 375, can be computed by using the geometry equations defining lines 370 and 367. In this way, the plane equation of the clipping plane 375 can be calculated.

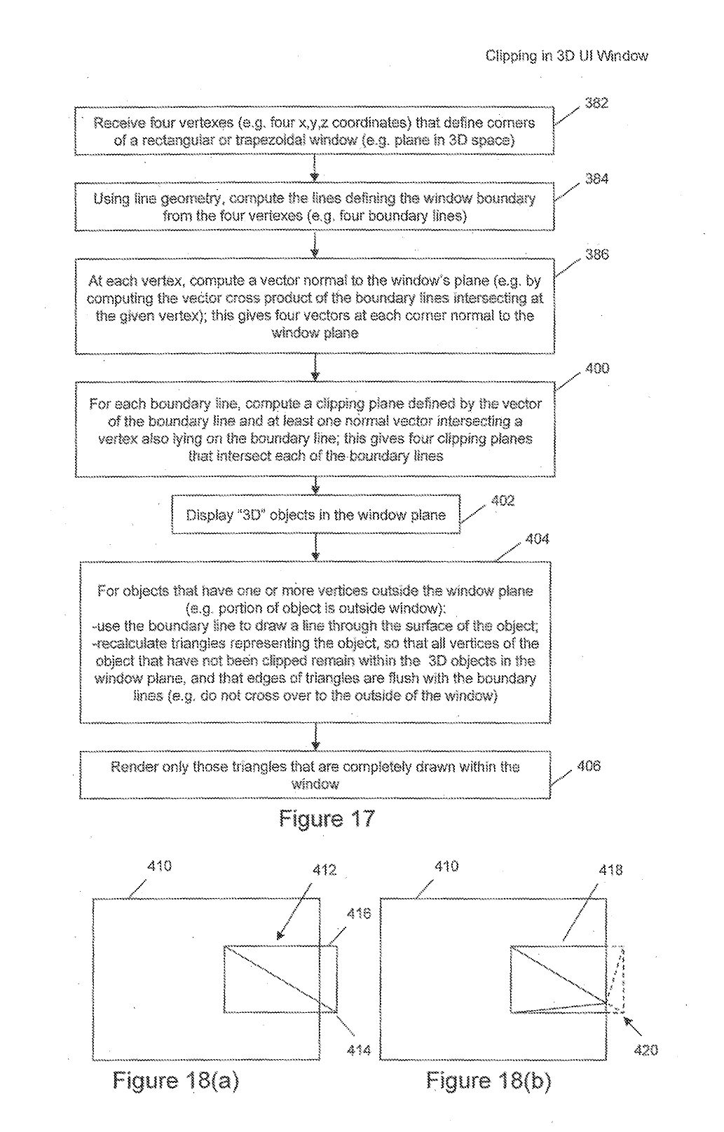

Turning to FIG. 17, example computer executable instructions are provided for clipping in 3D UI window (e.g. using module 58). This has the advantage of only displaying content that is within the window 360, and not outside the window 360. Content that is outside the window 360 is clipped off.

At block 382, four vertices comprising x,y,z coordinates are received. These vertices (e.g. vertices 361, 362, 363, 364) define corners of a rectangular or trapezoidal window, which is a plane in 3D space. It can be appreciated that other shapes can be used to define the window 360, whereby the number of vertexes will vary accordingly.

At block 384, using line geometry, the lines (e.g. lines 365, 366, 367, 368) defining the window boundary from the four vertices are computed. At block 386, at each vertex, a vector normal to the window's plane is computed. This is done by taking the vector cross product of the boundary lines intersecting the given vertex. This results in four vectors (e.g. vectors 369, 370, 371, 372) at each corner normal to the window plane. At block 400, for each boundary line, compute a clipping plane defined by the vector of the boundary line and at least one normal vector intersecting a vertex also lying on the boundary line. This results in four clipping plane that intersect each of the boundary lines. At block 402, the “3D” objects are displayed in the window plane.

The objects (e.g. buttons, panels in the calendar, pop-up reminder, etc.) are composed of a fragments or triangle surfaces. Some objects, such as those at the edge of the window 360, have one or more vertices outside the window boundary. In other words, a portion of the object is outside the window 360 and need to be clipped. The clipping of the image means that the portion of the object outside the window is not rendered, thereby reducing processing time and operations. To clip the portion of the object outside the window 360, a boundary line is used to draw a line through the surface of the object. Triangle surfaces representing the objects are recalculated so that all vertices of the object that have not been clipped remain within the 3D objects in the window plane. Additionally, the triangles are recalculated so that the edges of the triangles are flush with the boundary lines (e.g. do not cross over to the outside area of the window). At block 406, only those triangles that are completely drawn within the window are rendered.

FIGS. 18(a) and 18(b) illustrate an example of the triangle recalculation. The window 410 defines boundaries, and the object 412 has crossed over the boundaries. The object 412 is represented by two triangles 414, 416, a typical approach in 3D surface rendering. The triangles 414, 416 are drawn in a way as if there were no clipping planes. A vertex common to both triangles 414, 416 is outside the boundary of the window 410. Therefore, as per FIG. 18(b), the triangles are calculated to ensure all vertexes are within the boundaries defined by the clipping planes. The clipping planes are used as inputs to the math that achieves these “bounded” triangles. It is noted that the triangles drawn a single time, that is, after the clipping planes have been applied. The bounded triangles, for at least the portion of the object 418 within the window 410, are calculated and drawn so that all the vertices are within the window 410. Optionally, although not necessarily, the portion of the object 420 that is outside the window 410 is also processed with a new arrangement of triangles. Only the portion of the object 418 within the window 410 is rendered, whereby the triangles of the portion 418 are rendered.

The effects of zooming and scrolling are created by using similar techniques to clipping. Appropriate matrix transformations are applied to geometry of the objects to either change the size of the objects (e.g. zooming in or out) or to move the location of the objects (e.g. scrolling). After the matrix transformations have been completed, if one or more vertices are outside the window 260, then clipping operations are performed, as described above.

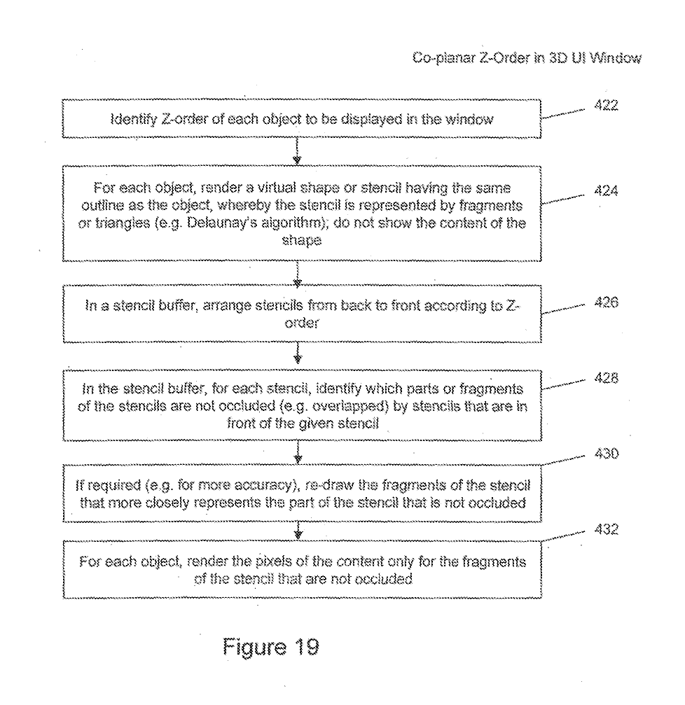

Turning to FIG. 19, example computer executable instructions are provided for determining the Z order in the 3D UI window (e.g. using module 60). The arrangement of the Z-order of objects in the 3D UI window does not require a pixel buffer. The Z-order represents the order of the objects along the Z-axis, whereby an object in front of another object blocks out the other object. In this case, as the window 360 may be angled within the 3D space, the Z-axis is determined relative to the plane of the window. The Z-axis of the window is considered to be perpendicular to the window's plane.

At block 422, the Z-order of each object that will be displayed in the window is identified. Typically, the object with the highest numbered Z-order is arranged at the front, although other Z-order conventions can be used. At block 424, for each object, a virtual shape or stencil is rendered. The stencil has the same outline as the object, whereby the stencil is represented by fragments or triangles. The content (e.g. colors, textures, shading, text) of the object is not shown. At block 426, in a stencil buffer, the stencils corresponding to the objects are arranged from back to front according to the Z-order. At block 428, in the stencil buffer, for each stencil, it is identified which parts or fragments of the stencils are not occluded (e.g. overlapped) by using the Z-ordering data and the shapes of the objects. At block 430, if required (e.g. for more accuracy), the fragments of the stencil recalculated to more closely represent the part of the stencil that is not occluded. At block 432, for each object, the pixels are rendered to show the content for only the fragments of the stencil that are not occluded. It can be appreciated that this ‘stencil’ and Z-ordering method allows 3D objects to be correctly depth buffered.

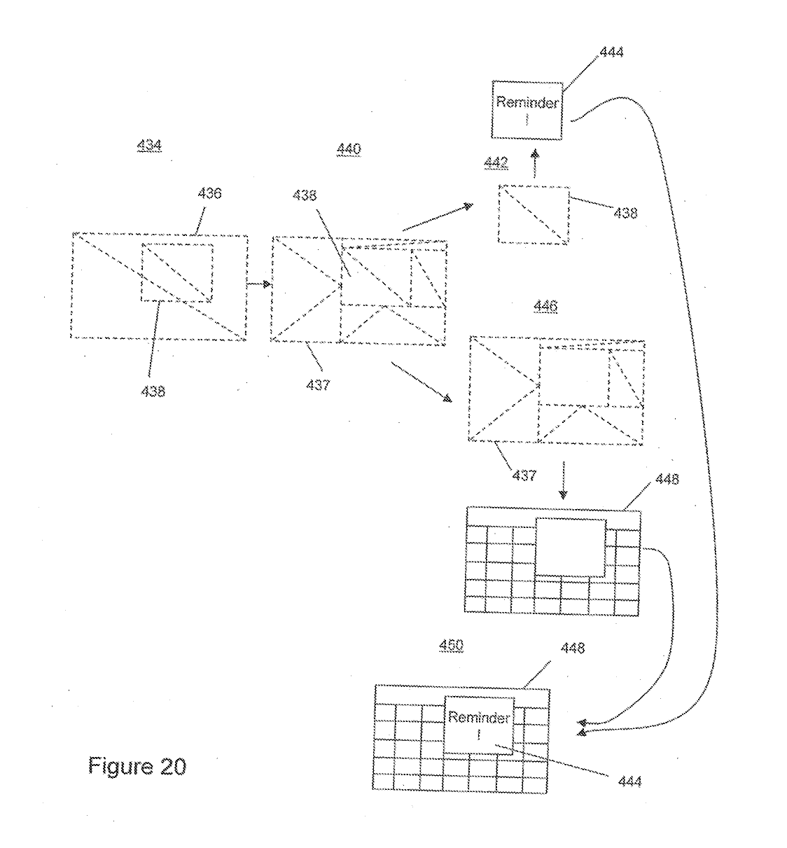

Turning to FIG. 20, an example of rendering the Z-order for a calendar and a pop-up reminder is shown, suitable for 3D scenes and without the use of a pixel buffer. As described, the objects in a window, such as a calendar and pop-up reminder, are comprised of fragment surfaces (e.g. triangles), which is a typical 3D rendering approach. At stage 434, a calendar stencil 436 and a pop-up stencil 438 are shown without the content being rendered. The pop-up stencil 438 is in front of the calendar stencil 436 since, for example, the pop-up has higher Z-order. Therefore, part of the calendar stencil 436 is occluded by the pop-up stencil 438.

At stage 440, a modified calendar stencil 437 is recalculated with the fragments or triangles drawn to be flush against the border of the occluded area defined by the pop-up stencil 438. As can be best seen in the exploded views 442, 446, the pop-up stencil 438 is one object and the calendar stencil 437 is another object, whereby fragments are absent in the location of the pop-up reminder. Based on the stencils, the content can now be rendered. In particular, the pop-up stencil 438 is rendered with content to produce the pop-up reminder object 444, and the modified calendar stencil 437 is rendered with content to produce the calendar object 448. It is noted that the calendar content located behind the pop-up reminder object 444 is not rendered in order to reduce processing operations. At stage 450, the pop-up reminder object 444 is shown above the calendar object 448. It can be seen that the Z-ordering method described here directly renders the objects within the window of a 3D scene and does not rely on a pixel buffer.

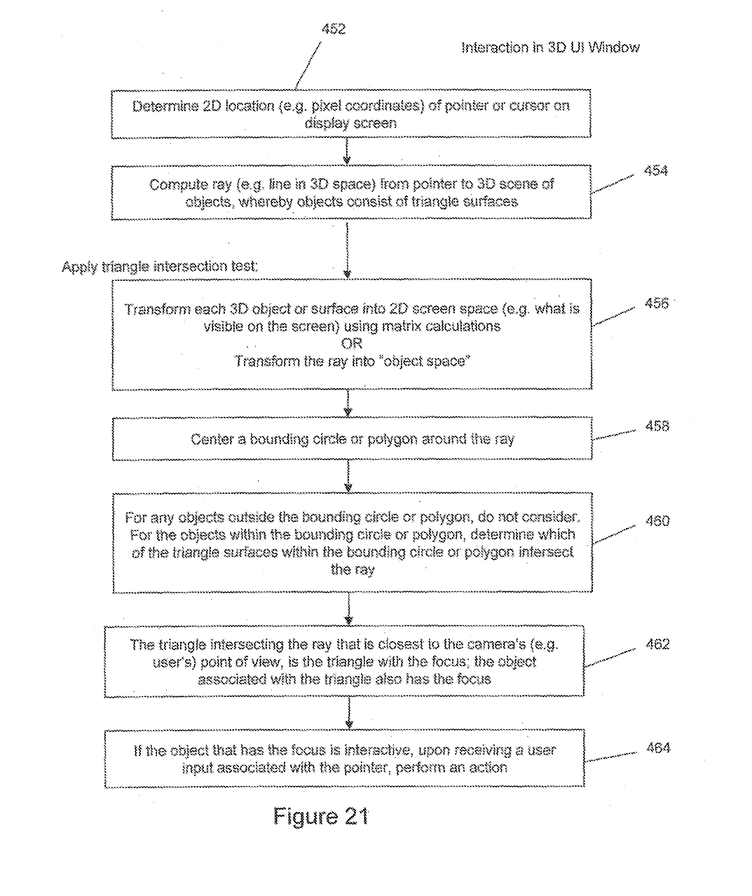

Turning to FIG. 21, example computer executable instructions are provided for interacting with objects in a 3D UI window (e.g. using module 62). As the window, and its components therein, are considered 3D objects in a 3D scene, the user interaction applies principles similar to those in 3D GUIs. The interaction described here is related to a pointer or cursor, although other types of interaction using similar principles can also be used. At block 452, the 2D location (e.g. pixel coordinates) of the pointer on the display screen is determined. At block 454, the ray (e.g. line in 3D space) is computed from the pointer to the 3D scene of objects. As noted above, the objects consist of triangle surfaces or other geometrical fragments. The triangle intersection test is then applied. At block 456, each 3D object or surface is transformed into 2D screen space using matrix calculations. 2D screen space refers to the area visible on the display screen. Alternatively, the ray from the pointer can be transformed into “object space”. Object space can be considered as the coordinates of that are local to an object, e.g. local coordinates relative to only the object. The object is not transformed by any transformations in the tree above it. In other words, as the object moves or rotates, the local coordinates of the object remain the same or unaffected.

At block 458, a bounding circle or bounding polygon is centered around the ray. This acts as a filter. In particular, at block 460, any objects outside the bounding circle or polygon are not considered. For objects within the bounding circle or polygon, it is determined which of the triangle surfaces within the bounding circle or polygon intersect the ray. At block 462, the triangle intersecting the ray that is closest to the camera's point of view, (e.g. the user's point of view on the display screen) is considered to be the triangle with the focus. The object associated with the intersecting triangle also has the focus. At block 464, if the object that has the focus is interactive, upon receiving a user input associated with the pointer, an action is performed. It can be appreciated that the above operations apply to both windowing and non-windowing 3D UIs. However, as the objects in the 3D UI window do not have depth and are coplanar with the window, the topmost object (e.g. object with highest Z-order) has the input focus, if it intersects with the ray.

It can be seen that by rendering the objects in a window plane as 3D objects, that a 2D buffer is not required when clipping, Z-ordering, or interacting with the objects in the window.

In another aspect of the 3D UI, a data structure is provided to more easily organize and manipulate the interactions between objects in a 3D visualization. Specifically, the images that represent objects or components in a 3D visualization can be represented as a combination of 3D objects. For example, if a 3D visualization on a screen shows a building, two trees in front of the building and a car driving by, each of these can be considered objects.

A 3D UI modeling tool is provided to create definitions or models of each of the objects. The definitions include geometry characteristics and behaviors (e.g. logic, or associated software), among other data types.

The application accesses these definitions in order to create instances of the objects. The instances do not duplicate the geometry or behavioral specifications, but create a data structure so each model can have a unique copy of the variables. Further details regarding the structure of the definitions, instances and variables are described below.

During operation, variable values and events, such as user inputs, are specified to each instance of the object. The processing also includes interpreting the behaviors (e.g. associated computer executable instructions) while rendering the geometry. Therefore each instance of the model, depending on the values of the variables, may render differently from others instances.

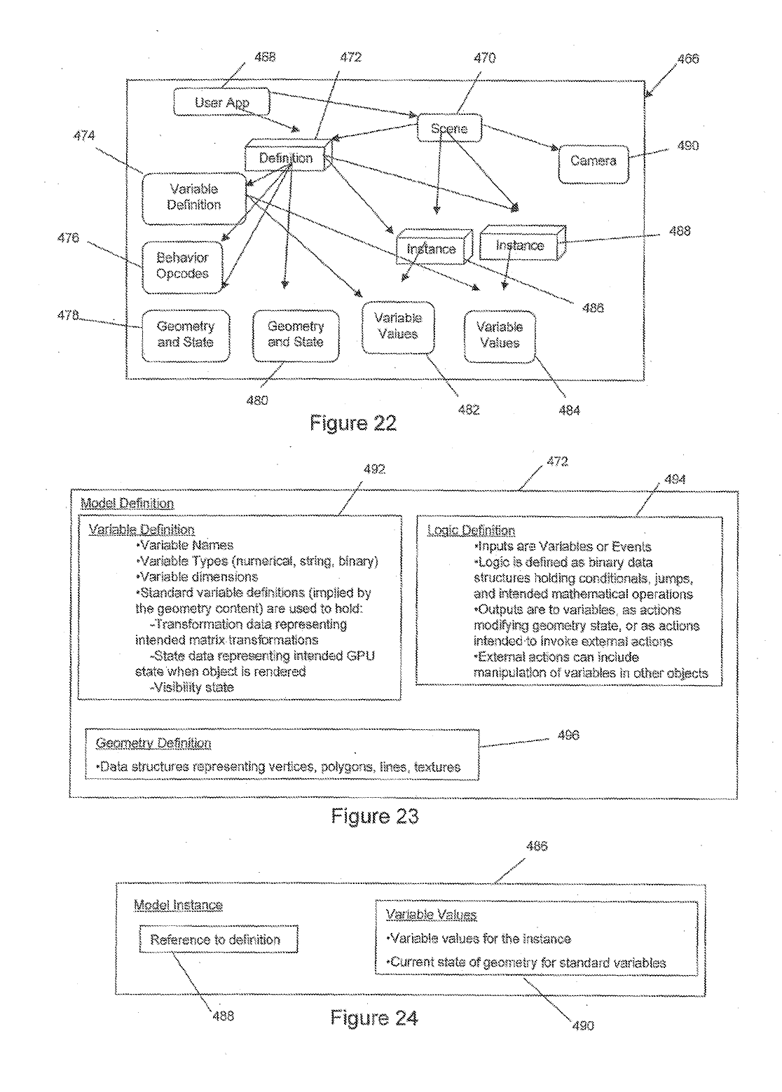

Turning to FIG. 22, an example of different data types and their interactions are provided to manage and organize the display of objects in a 3D scene (e.g. implemented by module 56). The scene management configuration 466 includes a user application 468. The application 468 receives inputs from a user or from another source to modify or set the values of variables that are associated with the objects, also called models. The scene 470 includes different instances of the models or objects. For example, a scene can be of a street, lined with buildings on the side, and cars positioned on the street. The area of the scene that is viewed, as well as from what perspective, is determined by the “camera” 490. The camera 490 represents the location and perspective from the user's point of view, which will determine what is displayed on the screen. The scene management configuration 466 also includes a model definition 472, which is connected to both the scene 470 and the user application 468. The model definitions 472 define attributes of a model or object as well as include variables that modify certain characteristics or behaviors of the object. The user application 468 uses the model definitions 472 to create instances 486, 488 of the model definition 472, whereby the instances 486, 488 of the model or object are placed within the scene 470. The instances 486, 488 overall have the same attributes as the model definition 472, although the variables may be populated with values to modify the characteristics or behaviors. Therefore, although the instances 486 and 488 may originate from the same model definition 472, they may be different from one another if the variable values 482, 484 are different. The model definition 472 has multiple sub-data structures, including a variable definition 474, behavior opcodes 476 (e.g. operation codes specifying the operation(s) to be performed), and geometry and states 478, 480. The types of data populating each sub-data structure will be explained below. However, as mentioned earlier, the structure of model definitions 472 allow for different instances of objects to be easily created and managed, as well as different objects to interact with one another within a 3D scene 470.

Turning to FIG. 23, a data structure of a model definition 472 is provided, including its sub-data structures of the variable definition 492, logic definition 494 and geometry definition 496. The variable definition 492 corresponds with the variable definition 474 of FIG. 22. Similarly, the logic definition 494 corresponds with the behavior opcodes 476, and the geometry definition 496 corresponds with the geometry and states 478, 480.

Continuing with FIG. 23, the variable definition 492 includes data structures for variable names, variable types (e.g. numerical, string, binary, etc.), variable dimensions or units and standard variable definitions. The standard variable definitions are implied by the geometry content and are used to hold transformation data representing intended matrix transformations, state data representing the intended GPU states when the object is rendered, as well as the visibility state. The matrix transformations are considered to be instructions as to how something moves, and can encode a scaling value, rotation value, translation value, etc. for a geometry manipulations. It can be appreciated that a series of such matrix transformation can generate an animation. GPU states can include information such as color, lighting parameters, or style of geometry being rendered. It can also include a other software applications (e.g. pixel or vertex shaders) to be used in the interpretation of the geometry. The visibility state refers to whether or not an object is rendered.

The logic definition 494 receives inputs that can be values associated with variable or events. The logic is defined as binary data structures holding conditional parameters, jumps (e.g. “goto” functions), and intended mathematical operations. Outputs of the logic populate variables, or initiate actions modifying the geometry of the object, or initiate actions intended to invoke external actions. External actions can include manipulation of variables in other objects.

The geometry definition 496 contains data structures representing vertices, polygons, lines and textures.

Turning to FIG. 24, an example data structure of a model instance 486 is shown. The model instance 486 is a certain instance of a model definition 492, having defined variable values 490 of the model definition 472. The variable values 490 include the values of the instance, as well as the current state of the geometry for the standard variables. The current state of the geometry for standard variables can include, for example, values used for the matrix commands and values identifying the colors to be set for the GPU color commands. Each model instance 486 also has a reference 488 to a model definition from which it originated.

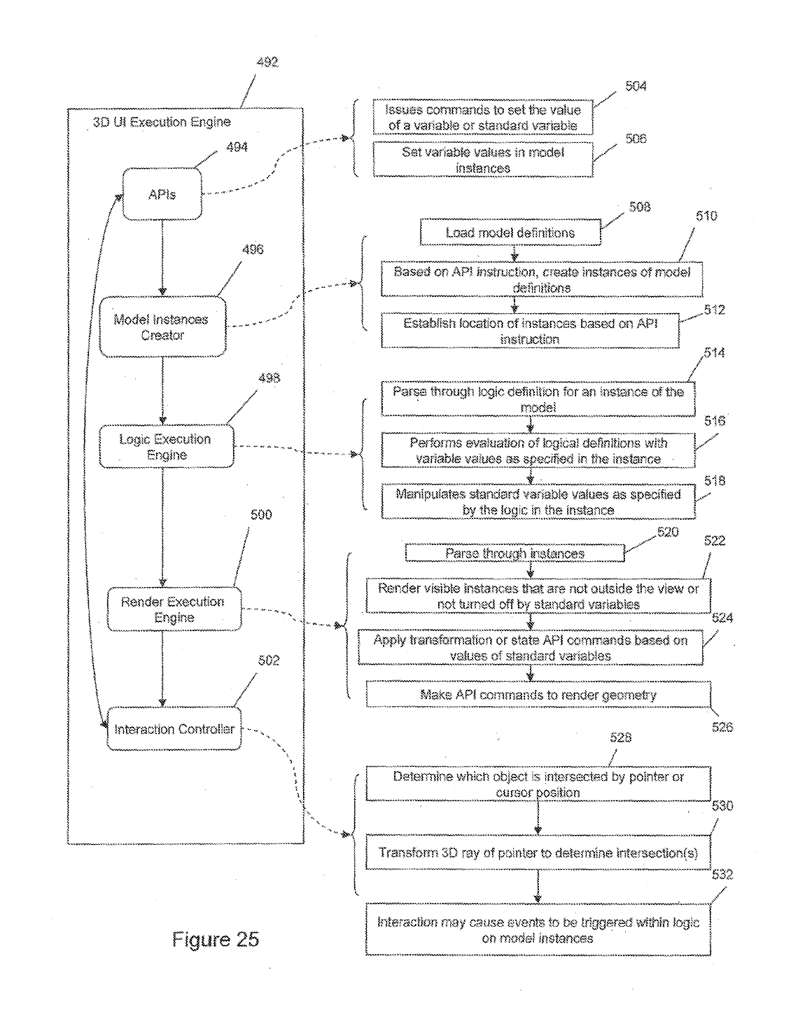

FIG. 25 shows an example configuration of a 3D UI engine 492 for manipulating and organizing the data structures in a scene management configuration 466. The 3D UI engine 492 comprises several modules, including Application Programming Interfaces (APIs) 494, a model instance creator 496, a logic execution engine 498, a render execution engine 500, and an interaction controller 502.

The APIs 494 issue commands to set the value of a variable or standard variable (block 504), as well as set the values in model instances (block 506). These commands to determine the values are passed to the model instances creator 496. In order to create a model instance, the model definitions are loaded (block 508). Then, the model instances creator 496 uses the values of the variables and commands received from the APIs 494 to create instances of the model definitions (block 510). In other words, the model instances are populated with the variable values provided by the APIs 494. As the model instance is typically considered an object in 3D space, at block 512, the location (e.g. spatial coordinates) of the model instance is then established based on the API commands.

Upon creating a model instance, the logic execution engine 498 parses through the logic definition (e.g. computer executable instructions) related to the model instance (block 514). Based on the logic definition, the logic execution engine 498 implements the logic using the variable values associated with the model instance (block 516). In some cases, the logic definitions may alter or manipulate the standard variable values (block 518). Standard variables can refer to variables that are always present for a given type of object. Additional variables may exist that are used to do additional logic, etc for variants of the object. It can be appreciated, however, that the notion of a standard variable and the notion of general variables are flexible and can be altered based on the objects being displayed in a 3D scene.

The render execution engine 500 then renders or visually displays the model instances, according to the applied logic transformations and the variable values. At block 520, the render execution engine 500 parses through the model instances. Those model instances that are within the view of the display (e.g. from the perspective of the virtual “camera”) and have not been turned off (e.g. made invisible) by standard variables, are rendered (block 522). The transformations that have been determined by the logic execution engine 498 and API commands altering the state variables are applied (block 524). In other words, matrices are read from memory and passed to GPU commands (e.g. “set current matrix”). Similarly, color values, etc. are read from memory and passed via the API to the GPU. At block 526, the API commands can also be used to render the geometry, whereby the geometry in the data structure exists as a set of vertex, normal, and texture coordinates. These API commands, such as “draw this list of vertices now”, are passed to the GPU.

The interaction controller 502 allows for a user input to interact with the rendered objects, or model instances. In the example of a pointer or cursor, at block 528, it is determined which object is intersected by a pointer or cursor position. This is carried out by creating a 3D ray from the pointer and determining where the ray intersects (block 530). Once interaction with a selected model instance is recognized, events may be triggered based on the logic associated with the selected model instance (block 532).

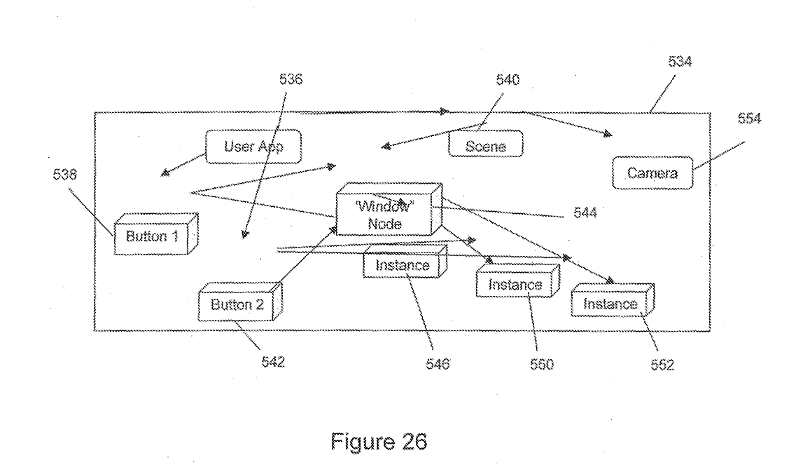

Another example of a scene management configuration 534 is shown in FIG. 26 and is directed to windowing, as discussed earlier with respect to FIGS. 15 and 16. A user application 536, such as a calendar application, may have model definitions for a first button 538 and a second button 542. The application 536 interacts with the 3D scene 540, whereby the 3D scene 540 includes a window node 544. The 3D scene 540 can be viewed by a virtual “camera” 554 (e.g. the location and perspective of the 3D scene made visible on the display screen). The window node 544 represents the window object, which as described earlier, is a window on a plane in 3D space. The application 536 provides variables to define certain instances of the button definitions 538, 542 which are displayed within the window node 544. Example variables of the button instances 546, 550, 552 could be the Z-order, the size, the color, etc. Logic may also be associated with the button instances 546, 550, 552, such as upon receiving a user input, initiating an action provided by the application 536. It can be appreciated that the scene management strategy, including its data structures and execution engine, can be applied to a variety of 3D scenes and objects.

The scene management strategy described here also provides many advantages. The logic of an application is expressed as data instead of compiled source code, which allows for ‘safe’ execution. This has similarities to interpreted languages such as Java, but has a far smaller data-size and higher performance.

The scene management strategy also provides the ability to represent geometry of an application in a GPU-independent manner. In other words, geometric commands can be rendered on almost any graphics API, which is very different from APIs that allow geometry rendering commands to be contained within Java. Further, by representing geometry in a GPU-independent manner, optimization of rendering can be implemented to suit back-end applications.

The scene management strategy can represent intended user interaction of an application without code. The existing or known systems are typically weak in their ability to represent the full dynamics of an application. However, the data structures (e.g. definitions and instances) of the models allow for logic to be encoded, enabling the models to react to user stimulus or inputs. Although some known web languages can encode logic, they are not able to correlate the logic to 3D geometry and their logic is limited to use within an internet browser. Additionally, such web language systems are data intensive, while the scene management strategy requires few data resources.

The scene management strategy also has the ability to ‘clone’ a single object definition to support a collection of similar objects (e.g. instances). There are ‘smart’ widget libraries existing entirely as data structures and instances, or as tailored hand code within smart UI system. This efficiently organizes the definitions and the instances, thereby reducing the memory footprint and application size. It also allows ease of development from a collection of 3D model objects.

Applications of the scene management strategy are varied because it is considered fundamental data strategy, which is not market specific. It also supports content-driven application development chains where an execution engine can be embedded inside a larger system. For example, the 3D UI execution engine 492 can be embedded inside a gaming environment to produce user-programmable components of a larger application engine. It can also be used to support new device architectures. For example, UI or graphics logic generated using the scene management strategy can be supplied by an embedded system with no physical screen, and then transmitted to another device (e.g. a handheld tablet) which can show the UI. This would be useful for displaying data on portable medical devices.

The scene management strategy can also be used to offer ‘application’ GUIs within a larger context, beyond computer desktops. An example would be a set of building models in a geographic UI, where each building model offered is customized to the building itself (e.g. an instance of the building model definition). For example, when a user selects a building, a list restaurants in the building will be displayed. When selecting a certain a restaurant, a menu of the restaurant will be displayed. All this related information is encoded in a building model.

In another aspect, a method is provided for enhancing a 3D representation by combining video data with 3D objects. Typically, due to the complexity of geospatial data (e.g. LiDAR data), generating a 3D model and creating a visual rendering of the 3D model can be difficult and involve substantial computing resources. Therefore, 3D models tend to be static. Although there are dynamic or moving 3D models, these also typically involve extensive pre-computations. Therefore, the method provided herein addresses these issues and provides a 3D representation that can be updated with live video data. In this way, the 3D representation becomes dynamic, being updated to correspond with the video data.

Generally, the method involves combining the video data, such as image frames for a camera sensor, are correlating the images with surfaces of a 3D model (e.g. also referred to as the encoding stage). This data is then combined to generate or update surfaces of a 3D model that correspond with the video images, whereby the surfaces are visually rendered and displayed on a screen (e.g. also referred to as the decoding stage).

The video data and 3D objects are also treated as a single seamless stream, such that live video data has the effect of ‘coating’ 3D surfaces. This provides several advantages. Since video data is associated with the 3D surfaces, and the 3D objects are the unit of display, then the video data can therefore be viewed from any angle or location. Furthermore, the method allows for distortion to occur; this takes into account the angle of the camera relative to the surface at which it has captured an image. Therefore, different viewing angles can be determined and used to render the perspective at which the video images are displayed. In another advantage, since video data and surface data can be computed or processed in a continuous stream, the problem of static 3D scenes is overcome. The method also allows for computed surfaces to be retained, meaning that only the changes to the 3D scene or geometry (e.g. the deltas) will need to be transmitted, if transmission is required. This reduces the transmission bandwidth.

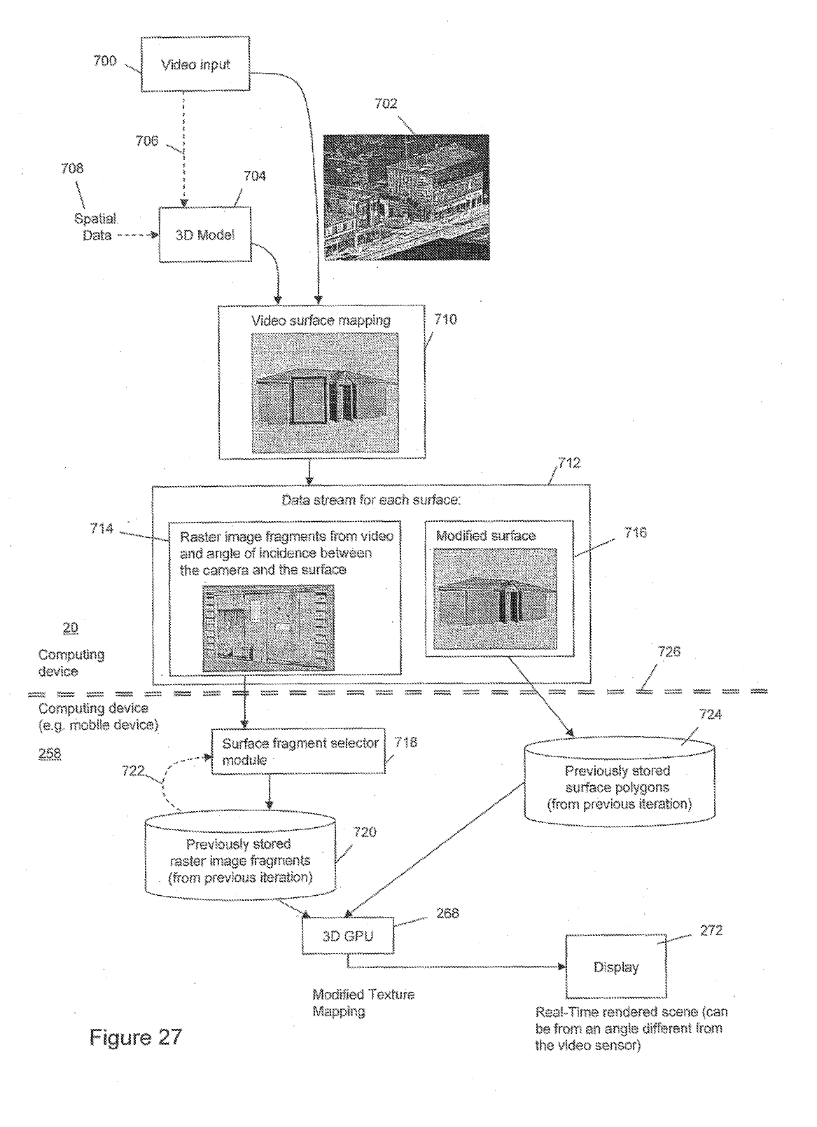

Turning to FIG. 27 an example system configuration suitable for 3D model video encoding and decoding is displayed. Such a system configuration and the associated operations can be implemented by module 64. As shown above the dotted line 726, in a preferred embodiment, certain of the operations can be performed by a computing device 20. Data that has been processed or encoded by the computing device 20 can be compressed and transmitted to another computing device 25 (e.g. a mobile device), for example having less processing capabilities. The other computing device 25, shown below the dotted line 726, can decompress and decode the encoded video and geospatial data, to display the video-updated 3D model.

Alternatively, the modules, components, and databases shown in FIG. 27 can all reside on the same computing device, such as on computing device 20. It can be appreciated that various configurations of the modules in FIG. 27 that allow video data and 3D models to be combined and updated are applicable to the principles described herein.

Continuing with FIG. 27, video input data (block 700) is received or obtained by the computing device 20. An example of such data is shown in the video image 702. The video input 700 typically includes a series of video frames or images of a scene. Associated with the scene is a 3D model 704. The 3D model can be generated from spatial data 708 (e.g. point cloud data. CAD models, etc.) or can be generated from the video input 700. For example, the pixels in the video input 700 can be used to reconstruct 3D models of buildings and objects, as represented by line 706 extending between the video input 700 and the 3D model 704.

There are several approaches for extracting or generating surfaces and 3D models from 2D video data. In one approach, voxel calculations are used to match points in an image taken from different camera angles, or in some cases from a single camera angle. The multiple points found in both images are computed based on colors and pattern matching. This forms a 3d ‘voxel’ (volume pixel) representation of the object. The change in point location over a set of frames may be used to assist surface reconstruction, as is done in the POSIT algorithm used in video game tracking technology. Pose estimation, e.g. the task of determining the pose of an object in an image (or in stereo images, image sequence), can be used in order to recover camera geometry.

Another approach for extracting surfaces from a 2D video is polygonization, also referred to as surface calculation. A known algorithm such as “Marching Cubes” may be used to create a polygonal representation of surfaces. These polygons may be further reduced through computing surface meshes with less polygons. An underlying ‘skeleton’ model representing underlying object structure (such as is used in video games) may be employed to assist the polygonization process. A convex hull algorithm may be used to compute a triangulation of points from the voxel space. This will give a representation of the outer edges of the point volume. Mesh simplification may also be used to reduce the data requirements for rendering the surfaces. Once the polygons are formed, these constitute the surfaces used to generate the 3D model 704, which is used as input in the 3D model video encoding algorithm.

Surface recognition is another approach used to extract or generate 3D surfaces from 2D video. Once a polygonization is computed to a given level of simplification, the surfaces can be matched to the prior set of surfaces from an existing 3D model. The matching of surfaces can be computed by comparing vertices, size, color, or other factors. Computed camera geometry as discussed above can be used to determine what view changes have occurred to assist in the recognition.

Continuing with FIG. 27, the video input 700 and the 3D model 704 are correlated with one another using the video surface mapping module 710. Module 710 determines which of the image fragments, or raster image fragments, from the video input match the surfaces of a 3D model. For example, video input 700 may include an image frame of a building with brick walls. The corresponding 3D model would show the structure, including the surfaces, of the building. The module 710 extract the raster image (e.g. collection of pixels) of the building wall and associated with the corresponding surface of the 3D building model. The extracted raster images can also be considered image fragments, as they are typically portions of the image that correspond to a surface.

The video surface mapping module 710 outputs a data stream 712 of raster image fragments associated with each surface. In particular, the data stream includes the surface 716 being modified (e.g. the location and shape of the surface on the 3D model) as well as the related processed video data 714. The processed video data 714 includes the extracted raster image fragments corresponding to the surface 716, as well as the angle of incidence between the camera sensor and the surface of the real object. The angle of incidence is used to determine the amount of distortion and the type of distortion of the raster image fragment, so that, if desired, the raster image fragment can be mapped onto the 3D model surface 716 and viewed from a variety of perspective viewpoints without being limited to the distortions of the original image.

As discussed above, the data stream 712, in one embodiment, can be compressed and sent to another computing device 258, such as a mobile device. If so, the computing device 258 decompresses the data stream 712 before further processing. Alternatively, the data stream 712 can be processed by the same computing device 20.

It can be appreciated that the process of updating a 3D model with video data is an iterative and continuous process. Therefore, there are previously stored raster image fragments (e.g. from previous iterations) stored in database 720 and previously stored surface polygons (e.g. from previous iterations) stored in database 724. The data stream 712 is used to update the databases 720 and 724.

The raster images fragments and angle of incidence data 714 are processed through a surface fragment selector module 718. The module 718 selects the higher quality raster image data. In this case, higher quality data may refer to image data that is larger (e.g. more pixels) and is less distorted. As per line 722, the previously stored raster image fragments from database 720 can be compared with the incoming raster data by module 718, whereby module 718 determines if the incoming raster data is of higher quality than the previous raster data. If so, the incoming raster data is used to update database 720.

The surfaces 716 from the data stream 712 are also used to update the surface polygons database 724. The GPU 268 then maps the raster image data and the angle incidence from database 720 onto the corresponding surface stored in database 724. As described earlier, the GPU 268 may also use the angle of incidence to change the distortion of the raster image fragment so that it suits the surface it is being mapped towards. The GPU 268 then displays the 3D model, whereby the surfaces of the 3D model are updated to reflect the information of the video data. If the video data is live, then the updated 3D model will represent live data. Additionally, the 3D model is able to display the video-enhanced live scene from various angles, e.g. different from the angle of the video sensor.

From the above, it can be seen that as video frames are continuously obtained, the 3D model can be also be continuously updated to reflect the video input. This provides a “live” or “dynamic” feel to the 3D model.

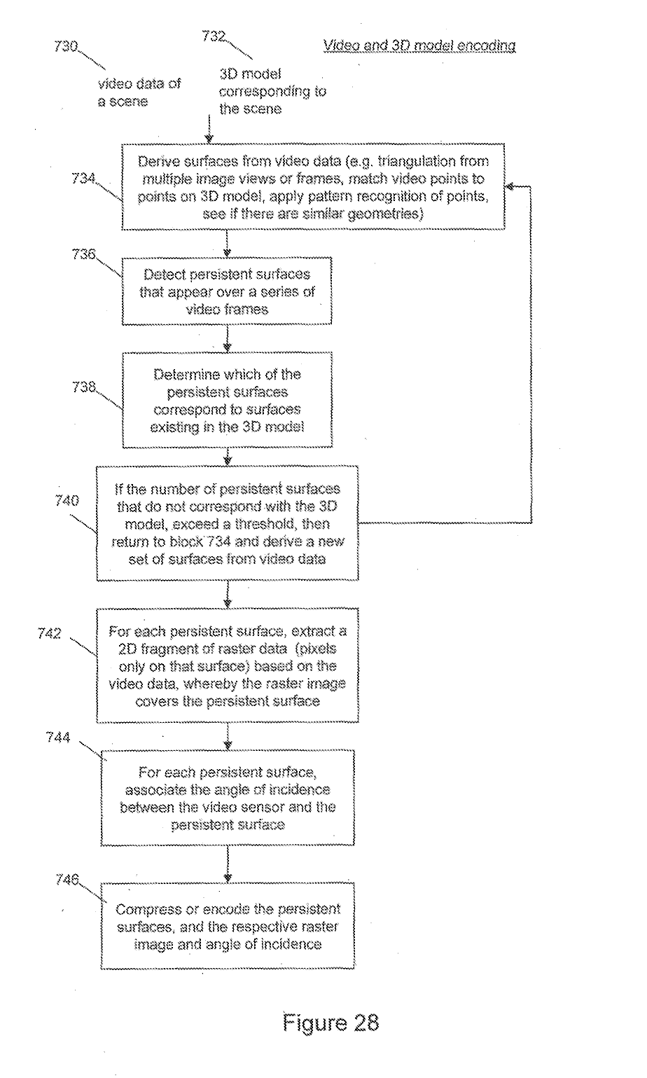

Turning to FIG. 28, example computer executable instructions are provided for extracting image fragments from video data according to associated surfaces of a 3D model (e.g. using module 66). The inputs, among others, include video data or input 730 of a scene and a 3D model 732 corresponding to the scene. At block 734, the surfaces from video data are extracted. In one example approach, surfaces are extracted using a process such as triangulation from multiple image views or frames, and video pixels corresponding to each surface fragment are assigned to a surface based on their triangulated location during the extraction process. Pattern recognition or other cues may be used to aid the surface identification process (e.g. identifying corners and edges).

At block 736, preferably, although not necessary, persistent surfaces in the video images or frames are detected. For example, surfaces that appear over a series of video frames are considered persistent frames. These surfaces are considered to be more meaningful data since they likely represent surfaces of larger objects or stationary objects. Persistent surfaces are can be used to determine the context for the 3D scene as it moves. For example, if the same wall, an example of a persistent surface, is identified in two separate image frames, then the wall can be used as a reference to characterize the surrounding geometry.

At block 738, it is determined which of the persistent surfaces correspond to the surfaces existing in the 3D model. The shape of a persistent surface is compared to surfaces of the 3D model. If there shapes are similar, then the persistent surface is considered to be a positive match to a surface in the 3D model.

At block 740, optionally, if the number of persistent surfaces that do not correspond with the 3D model exceed a given threshold, then the overall match between the video input data and the 3D model is considered to be poor. In other words, the data sets are considered to have low similarity. If so, then the process return to block 734 and a new set of surfaces are derived from the video data.

If the data sets are similar enough, then at block 742, for each persistent surface, a 2D fragment of raster data is extracted. The fragment of raster data are the pixels of the video image that compose the persistent surface. Therefore, the raster image covers the persistent surfaces. At block 744, for each persistent surface, the angle of incidence between the video or camera sensor and the persistent surface is determined and is associated with the persistent surface. The angle of incidence can be determined using known method. For example, points in the images can be triangulated, and the triangulated points can be used to estimate a camera pose using known computer vision methods. Upon determining the pose and the surface geometry, the angle between the camera sensor and the surface triangles is examined and used to determine an angle of incidence. The angle of incidence can be used to determine how the raster image is distorted, and to what degree. At block 746, the surface of the 3D model, and the associated raster image and angle of incidence can optionally be compressed and sent to another computing device 258 (e.g. a mobile device) for decoding and display. Optionally, the data can be displayed by the same computing device.

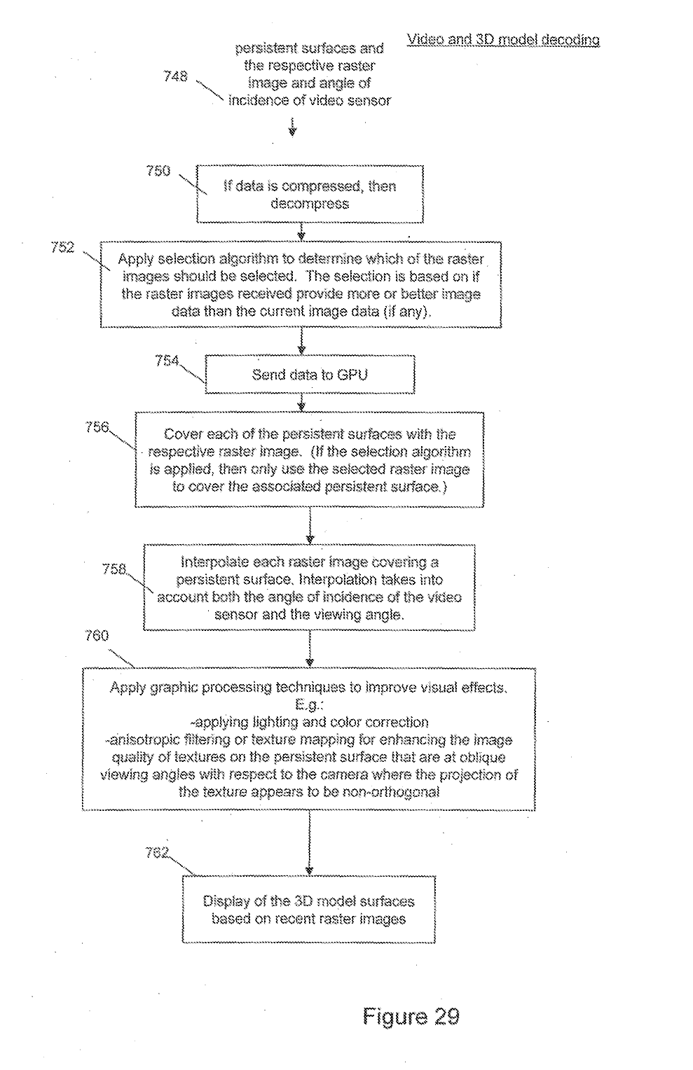

Turning to FIG. 29, example computer executable instructions are provided for mapping images from video data onto surfaces of a 3D model for display (e.g. using module 68). As a continuation from FIG. 28 the inputs 748 are the surface of the 3D model, and the associated raster image and angle of incidence. At block 750, if the input data 748 has been compressed, then it is decompressed. At block 752, a selection algorithm is applied to determine which of the raster images should be selected. The selection is based on if the raster images received provide more or better image data than the previously selected raster images associated with the same surface. If so, the new raster images are selected. If not, then the previously selected raster images are used again. If, however, no raster images have been previously selected (e.g. the first iteration, or a new surface is detected), then the received raster images are selected.

At block 754, the selected raster images, associated angles of incidence, and associated surfaces in the 3D models are sent to the GPU 268. At block 756, each of the persistent surfaces in the 3D models are covered with the respective raster images. The surfaces are “coated” or “covered” with the new raster images if the new raster images have been selected, as per block 752.

At block 758, each raster image covering a persistent surface is interpolated, as to better cover the persistent surface in the 3D model. The interpolation may take into account both the angle of incidence of the video sensor and the perspective viewing angle that will be displayed to the user on the display 272.

Regarding block 758, it can be appreciated that in standard or known perspective texture map rendering, texture coordinates are specified as U and V coordinates corresponding to the linear distances across the texture in the horizontal and vertical directions. By way of background, with perspective correct texturing, vertex locations of the textured object are transformed into depth values (e.g. values along the Z-axis) based on their distance from the viewer. The virtual camera location is used to compute vertex locations in screen space through matrix transformation of the vertices. Individual pixels of the rendered, textured object on the screen are computed by taking the texel value by interpolation of U and V based on the interpolated Z location. This has the effect of compressing the texture data as rendered.

However, in the present approach in block 758, the texture map as transmitted in the video encoding will not be adjusted to be a flat map. It will contain data that already contains the real world perspective effect of the surface raster fragment. The perspective effect depends on the angle of incidence at which the real world camera filmed the surfaces. This perspective data is associated with each surface triangle within a texture map. If the scene were rendered from the original camera's perspective, the texture mapping algorithm could be simplified by excluding the step of interpolating U and V, and just obtaining the texel corresponding to each of the fragments' interpolated Z location. This means the compression effect of perspective correction would not be applied, because the data already contains the perspective effect. This can also be accomplished by modifying the Z coordinate to eliminate its effect in the perspective calculation. In order to adjust the viewing angle so the surface fragment data can be viewed from a different camera location, a matrix calculation can be used to compute deltas to the modified Z coordinates to account for the different camera angles. Therefore the interpolation would contain an adjustment based on the original camera sensor angle (e.g. the angle of incidence between the camera and the surface). The interpolated screen pixel would reflect the original perspective in the camera image plus adjustments to account for different viewing angles from the viewer's perspective. This is similar to algorithms used in orthorectification and photogrammetry to recover building surface images from photographs, with the difference that it is being applied in real time to the video reconstruction process. Furthermore, that the algorithms may use the modified vertex and pixel shader programs in a GPU.

Continuing with FIG. 29, at block 760, the graphic processing techniques are applied to improve the visual display of the raster images on the 3D model surfaces. For example, known lighting and color correction algorithms are applied. Further, anisotropic filtering or texture mapping can be applied to enhance the image quality of the textures rendered on surfaces that are displayed at oblique angles with respect to the camera's perspective. Anisotropic filtering takes into account the angle of the surface to the camera to more clearly show texture and detail at various distances away from the camera. In other words, raster images, or textures derived thereof, that are displayed at non-orthogonal perspectives can be corrected for their distortion.

At block 762, the raster images are displayed on the 3D model surfaces. As the raster images update, surfaces on the 3D model can change. This allows the 3D model to have a dynamic and “live” behaviour, which corresponds to the video data.

It is appreciated that 3D model video encoding has many applications. By way of background, it is known that 2D imagery can be presented on planes within a 3D scene. However, known methods do not work well when the surface planes in the 2D image are viewed from oblique angles. The present 3D model video encoding method has the advantage of processing 2D video images, correcting those surfaces that are hard to view due to perspective angles, and displaying those surfaces in 3D more clearly from various angles. This technique can also be combined with virtual 3D objects to assist in placing video objects in context.

A ‘pseudo’ 3D scene can also be created. This is akin to the methods used to present ‘street views’ based on video cameras. Video imagery is captured using a set of cameras arranged in a pattern and stored. The video frames can be presented within a 3D view that shows the frames from the vantage point of the view, which can further be rotated around because video frames exist from multiple angles for a given view. The 3D view is not constrained to be presented from viewpoints and camera angles that correspond to the original sensor angles.

2D video images can also be used to statically paint a 3D model. In this case, georeferenced video frames are used to create static texture maps. This allows a virtual view from any angle, but does not show dynamically updating (live) data.

In an example application, a street scene is being rendered in 3D on a computer screen. This scene could be derived, for instance, from building models extracted from video or LiDAR, using method described above. The building models are stored in a database and transmitted over a network to a remove viewing device. A user would ‘virtually’ view the scene from a viewpoint standing on the street, in front of one of the buildings. In the real world, a car is going down the actual street, which is the same street corresponding to the virtual street depicted in the 3D scene. A video or camera sensor mounted on one of the buildings is imaging the real car. The 3D model video encoding method is able to process the video images; derive a series of surfaces that make up the car; encode a 3D model of that car's surfaces with imagery from the video mapped to the surfaces; and transmit the 3D model of the car as a live video ‘avatar’ to the remote viewer. Therefore, the car can be displayed in the 3D remote scene and viewed from different angles in addition to those angles captured by the original video camera. In other words, the remote viewer, from the vantage point of the street, could display the car moving down the street, even though the original video camera that identified the car was in a different location than the virtual viewpoint.

In another example, there is a conference with a set of participants, with some participants attending ‘virtually’. One of the participant's ‘virtual’ vantage point is at the head of a table. A set of sensors images the room from opposite corners of the ceiling. Algorithms associated with the sensor data would identify the room's contents and participants in the conference. The algorithms would then encode a set of 3D objects for transmission to a remote viewer. The virtual attendee could ‘attend’ the conference by displaying the 3D room and its participants on his large screen TV. By attaching a simple tracking device to the participant's headset (e.g. such as those used for simulation games), the participant could turn their head and look at each of the other participants as they spoke. The remote viewer would display the participants' 3D avatars, whereby the 3D avatars would be correctly positioned in the room according to their actual positions in the conference room. The scene, as displayed on the remote viewer, would be moving as the virtual attendee moved, giving the virtual attendee a realistic sensation of being at the table in the room.

It can therefore be seen that encoding a 3D model with 2D video has many applications and advantages, which are not limited to the examples provided herein.

In another aspect, systems and methods are also provided for allowing a user to determine how a 3D scene is viewed (e.g. using module 70). Navigation tools are provided, whereby upon receiving user inputs associated with the navigation buttons, the view of the 3D scene being displayed on a screen changes.

This proposed system and method for geospatial navigation facilitates user interaction with geospatial datasets in 3D space, particularly on mobile devices (e.g. smart phones, PDAs, mobile phones, pagers, tablet computers, net books, laptops, etc.) and embedded systems where user interaction is not performed on a desktop computer through a mouse. Some of the innovations are however also useful on the desktop, and the description is not meant to exclude it.

By way of background, geospatial data refers to polygonal data comprising ground elevation, potentially covering a wide area It can also refer to imagery data providing ground covering; 3D features and building polygonal models; volumetric data such as point clouds, densities, and data fields; vector datasets such as networks of roadways, area delineations, etc.; and combinations of the above.

Most 3D UI navigation systems make use of several methods to enable movement throughout a 3D dataset. These can include a set of UI widgets (e.g. software buttons) that enable movement or view direction rotation (e.g. look left, look right). These widgets may also provide a viewer with location awareness and the ability to specify a new location via dragging, point, or click. These methods are difficult to use when trying to precisely position a viewpoint relative to a point of interest. The navigation is typically performed relative to a users perspective, and therefore, can be imprecise when attempting to focus the virtual camera's view on a object.

Other known navigation methods include a pointing device, such as a mouse, which may be enabled to provide movement or view direction rotation. These methods are good for natural interaction, but again do not facilitate focus on a certain object.

One of the limitations with most navigation methods is that, although some may support ‘fly through’, they do not provide methods that allow a user to rapidly look at objects of interest. Another difficulty with most navigation interfaces is that they give poor awareness as to what is behind a viewer.

The proposed geospatial navigation system and method includes the behaviour of a ‘camera’ on a boom, similar to camera boom used to film movies. Camera booms, also called camera jibs or cranes, allow a camera to move in many degrees of freedom, often simultaneously. This navigation behaviour allows for many different navigation movements. In the geospatial navigation system, objects, preferably all objects, in the 3D scene become interactive. In other words, objects can be selected through a pointer or cursor.

The pointer or cursor can be controlled through a touch screen, mouse, trackball, track pad, scroll wheel, or other pointing devices. Selection may also be done via discrete means (e.g. jumping from target to target based on directional inputs). Upon selecting an object, the viewpoint of the display can be precisely focused on the selected object. Navigation buttons are provided for manipulating a camera direction and motion relative to a selected object or focus point, thereby displaying different angles and perspectives of the selected object or focus point. Navigation buttons are also provided for changing the camera's focus point by selecting a new object and centering the camera focus on the new object.

Inputs may also be used to manipulate ‘boom rotations’ about the focus object (azimuth and elevation) either smoothly or in discrete jumps through an interval or preset values. This uses the camera boom approach. These rotations can be initiated by selecting widgets, using a pointing device input, or through touch screen controls. The length of the camera boom may also be controlled, thereby controlling the zoom (e.g. the size of the object relative to the display area). The length of the boom may be manipulated using a widget, mouse wheel, or pinch-to-zoom touch screen, or in discrete increments tied to buttons, or menus. It can be appreciated that the representation of the navigation interfaces can vary, while producing similar navigation effects.

Example including activating a forward motion button, thereby translating or moving the virtual camera along the terrain, or up the side of a building. These motions take into account the intersection of the camera's boom with the 3D scene.

Other controls include elevating the virtual camera's location above the height of the ground, as a camera might be manipulated in a movie by elevating its platform.

Other camera motions that are interactive can be supported, such as moving the virtual camera along a virtual ‘rail’ defined by a vector or polygonal feature.

Navigation may be enhanced by linking a top-down view of a 2D map to the 3D scene, to present a correlated situation awareness. For instance, a top-down view or plan view of the 3D scene point may be displayed in the 2D map, whereby the map would be centered on the same focal point as the virtual camera's 3D focal point. As the camera's focal point moves, the correlated plan view in the 2D map also moves along. Additionally, as the virtual camera rotates, the azimuth of the camera's view is matched to the azimuth of the top-down view. In other words, the top-down view is rotated so that the upwards direction on the top-down view is aligned with the facing direction of the virtual camera. For example, if the virtual camera rotates to face East, then the top-down view consequently rotates so that the East facing direction is aligned with the upwards direction of the top-down view. The range of the 2D map, that is the amount of distance displayed in the plan view, can be controlled by altering the virtual camera boom length or height of the virtual camera above map in the 2D mode. This allows the 2D map to show a wide area, while the 3D perspective view is close up.

This method advantageously allows for precise and intuitive navigation around 3D geospatial data. Further, since the navigation method allows both continuous and discrete motions, a viewpoint can be precisely positioned and adjusted more conveniently. The method also allows both wide areas and small areas to be navigated smoothly, allowing, for instance, a viewer to transition from viewing an entire state to a street-level walk through view easily. Finally, the method is not reliant on specialized input devices or fine user motions based on clicking devices. This makes it suitable for embedded applications such as touch screens, in-vehicle interfaces, devices with limited inputs (e.g. pilot hat switch), or displays with slow refresh rates where controlling smooth motion is difficult.

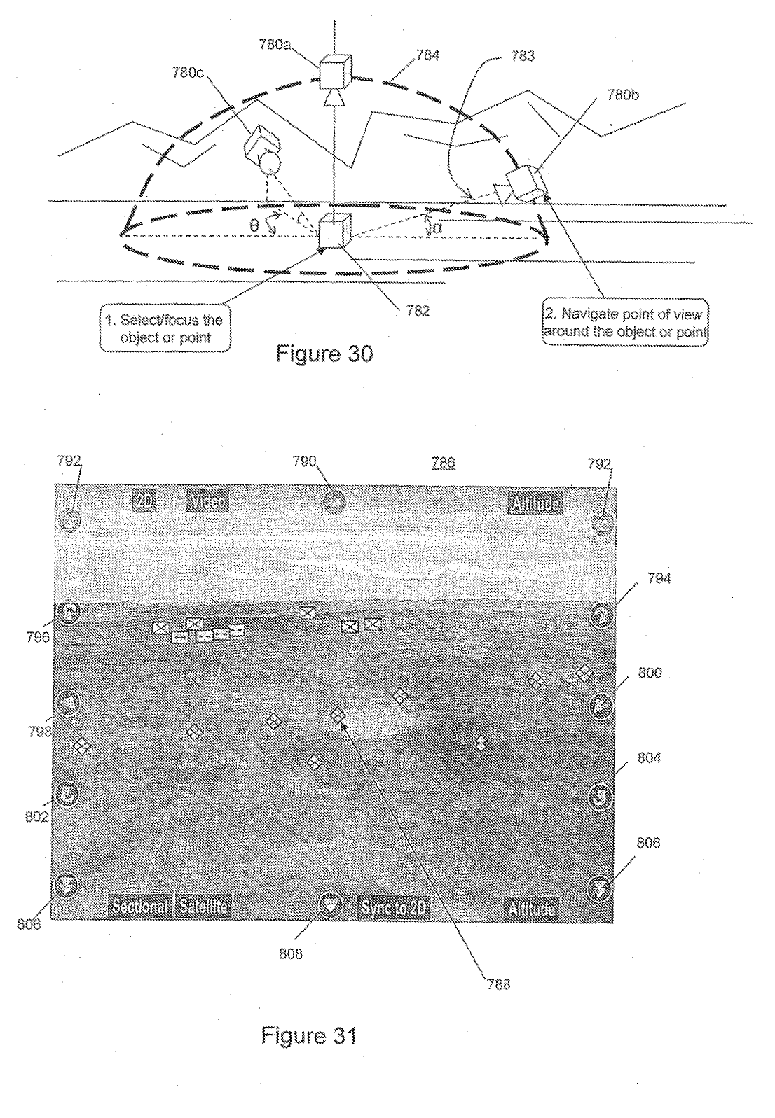

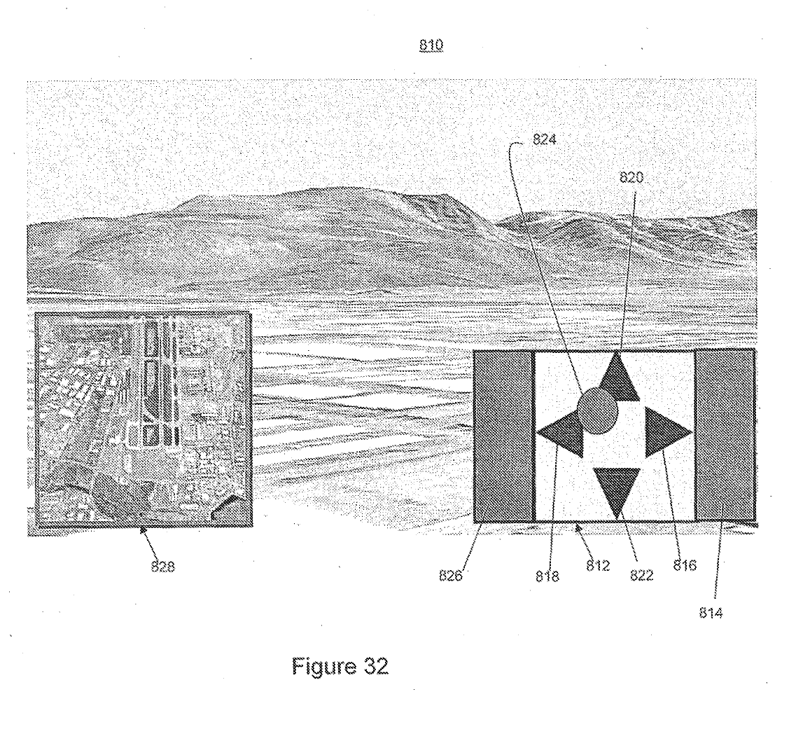

Turning to FIG. 30, a 3D scene of an object 782 is shown being positioned in the foreground with scenery in the background. FIG. 30 is a representation of how a 3D scene is navigated to produce screen images, which are shown in FIGS. 31 and 32. A camera 780 can be assigned a focus point, such as the object 782, and oriented relative to the focus point to view the focus point from different positions and angles. The camera 780, also called the virtual camera, represents the location and angle at which the 3D scene is being viewed and displayed on a display screen. In other words, the camera 780 represents the user's viewing perspective. As represented by the suffixes, the camera 780 can have multiple positions, examples of which are shown in FIG. 30. Camera 780a is positioned directly above the object 782, capturing a plan view or top-down view of the object 782. Therefore, the display screen will show a plan view of the object 782. Through a navigation button, not shown here, the elevation angle of the camera 780 can change, while the camera 780 still maintains the object 782 as its focus point. For example, camera 780b has a different elevation angle α above the horizontal plane, compared to camera 780a. Camera 780b maintains the object 782 as the focus point, although a different angle or perspective of the object 782 is captured (e.g. a partial elevation view). The azimuth angle of the camera 780 can also be changed through navigation controls. Camera 780c has a different azimuth angle θ than camera 780b, therefore showing a different side of object 782. It can be appreciated that the position of camera 780 can vary depending on the azimuth and elevation angles relative to a focus point, such as the object 782, thereby allowing different angles and perspectives of a focus point to be viewed. Dotted lines 784 represent the spherical navigation path of the camera 780, which allows a focus point to be viewed from many different angles, while still maintaining the focus point at the center of the display screen. The distance between the camera 780 and the focus point, or object 782, can be varied. This changes the radius of the spherical navigation path 784. Line 783 shows a radial distance between the object 782 and the camera 780b. A closer distance between the camera 780 and the focus point means that the screen view is zoomed-in on the focus point (e.g. the focus point is larger), while a further distance means that the screen view is zoomed-out on the focus point (e.g. the focus point is smaller). Other navigation motions are also available, which are discussed with respect to FIGS. 31 and 32.

Turning to FIG. 31, a screen shot 786 of an example graphical user interface for controlling geospatial navigation is provided. At the center of the screen 786 is a focus point 788, which indicates the location of the center of focus for the user's perspective. Buttons or screen controls 794 and 796 are used to control the elevation view. For example, elevation button or control 794 increases the angle of elevation, while still maintaining focus point 788 at the center of the screen 786. Similarly, elevation button or control 796 decreases the angle of elevation, while maintaining the focus point 788. It can be understood that selecting elevation control 794 can change the viewing perspective towards a top-down view, while selecting elevation control 796 can change the viewing perspective towards a bottom-down view.

Azimuth buttons or controls 804 and 802 change the azimuth of the viewing angle, while still maintaining focus point 788 at the center of the screen, although from different angles. For example, upon receiving an input associated with azimuth button 804, the perspective viewing angle of the focus point 788 rotates counter clockwise. Upon receiving an input associated with azimuth button 802, the perspective viewing angle rotates clockwise about the focus point 788. In both the elevation and azimuth navigation changes, the geospatial location of the focus point within the 3D scene remains the same.

Zoom buttons or controls 792 and 804 allow for the screen view to zoom in to (e.g. using zoom button 792) and zoom out from (e.g. using zoom button 804) the focus point 788. Although the zoom settings may change, the geospatial location of the focus point 788 within the 3D scene remains the same.

In order change focus points, forward translation button 790 and backward translation button 808 can be used to advance the camera view point forward and backward, respectively. This is similar to moving a camera boom forward or backward along a rail. For example, upon receiving an input associated with forward translation button 790, the screen view translates forward, including the focus point 788. In other words, a new focus point having a different location coordinates is selected, whereby the new focus point is at the center of the screen 786. Similarly, the spatial coordinates of the focus point 788 changes when selecting any one of sideways translation buttons 798 and 800. When selecting the right translation button 800, the screen view shifts to the right, including the location of the focus point 788.

Turning to FIG. 32, another example of a screen shot 810 suitable for geospatial navigation in a 3D scene is provided. The screen shot 810 shows a perspective view of a 3D scene, in this case of flat land in the foreground and mountains in the background. The screen shot 810 also includes a control interface 812 and a top-down view 828, which can also be used to control navigation. Control interface 812 has multiple navigation controls. Zoom button or control 814 allows the screen view to zoom in or zoom out of a focus point. If a pointer is used, by moving the pointer up along bar of the zoom button or control 814, the screen view zooms in to the focus point. Similarly, moving the pointer down along the zoom button 814 causes the view to zoom out. In a touch screen device with a multi-touch interface, a user's inward pinching action along the zoom button or control 814 can cause the screen view to zoom in, while upon detecting an outward pinching action the screen view zooms out. This is commonly known as pinch-to-zoom.

Control interface 812 also has navigation controls for reorienting the azimuth and elevation viewing angles. Receiving an input associated with elevation control 820 (e.g. the upward arrow) causes the elevation angle of the screen view to increase, while receiving an input associated with elevation control 822 (e.g. downward arrow) causes the elevation angle to decrease. Receiving an input associated with azimuth control 816 (e.g. right arrow) causes the azimuth angle of the screen view to rotate in one direction, while receiving an input associated with azimuth control 818 (e.g. left arrow) causes the azimuth angle of the screen view to rotate in another direction. The change in the azimuth and elevation viewing angles are centered on a focus point.

A virtual joystick 824, shown by the circle between the arrows, allows the screen view to translate forward, backward, left and right. This also changes the 3D coordinates of the focus point. As described earlier, the focus point can be an object. Therefore, as a user moves through a 3D scene, new points or objects can be selected as the screen's focus, and the screen view can be rotated around the focus point or object using the controls described here.

Control interface 812 also includes a vertical translation control 826 which can be used to vertically raise or lower the screen view. For example, this effect is conceptually generated by placing the virtual camera 780 on an “elevator” that is able to move up and down. By moving a pointer, or in a touch screen, sliding a finger, up the vertical translation control 826, the screen view translates upwards, while moving a finger or sliding a finger downwards causes the screen view to translate downwards. This control 826 can be used, for example, ascend or descend the wall of a building in the 3D scene. For example, if a user wished to scan the side of a building from top-to-bottom, the user can set the building as the focus point. Then, from the top of the building, the user can use the vertical translation control 826 to move the screen view of the building downwards, while still maintaining a view of the building wall in the screen view.

Continuing with FIG. 32, the top-down view 828 shows the overhead layout of the 3D scene. The top-down view 828 is centered on the same focus point as the perspective view in the screen shot 810. In other words, as the focus point of the screen view changes from a first object to a second object, the top-down view 828 shifts its center from the location of the first object to the location of the second object. The top-down view 828 advantageously provides situational or contextual awareness to the user.

The top-down view 828 can also be used as control interface to select new focus points or focus object. For example, both the top-down view 828 and the perspective screen view may be centered on a first object. Upon receiving an input on the top-down view 828 associated with a second object shown on the top-down view 828, the focus point of the top-down view 828 and the perspective screen view shift to center on the location coordinates of the second object. In a more specific example, the perspective screen view and top-down view may be centered on a bridge. However, the top-down view 828 may be able to show more objects, such as a nearby building located outside the perspective screen view. When a user selects the building in the top-down view 828 (e.g. clicks on the building, or taps the building), the focus point of the top-down view 828 and the perspective screen view shift to be centered on the building. The user can then use the azimuth and elevation control to view the building from different angles. It can therefore be seen that the top-down view 828 facilitates quick navigation between different objects.

It can be appreciated that the above-described user interfaces can vary. The buttons and controls can be activated by using a pointer, a touch screen, or other known user interface methods and systems. It can also be appreciated that the above geospatial navigation advantageously allows for precise navigation and viewing around a 3D scene. Further, although the above examples typically relate to continuous or smooth navigation, the same principles can be used to implement discrete navigation. For example, controls or buttons for “ratchet” zooming (e.g. changing the zoom between discrete intervals) or ratchet azimuth and elevation angle shifts can be used to navigate a 3D scene.

In general, a method is provided for displaying data having spatial coordinates, the method comprising: obtaining a 3D model, the 3D model comprising the data having spatial coordinates; generating a height map from the data; generating a color map from the data; identifying and determining a material classification for one or more surfaces in the 3D model based on at least one of the height map and the color map; based on at least one of the 3D model, the height map, the color map, and the material classification, generate one or more haptic responses, the haptic responses able to be activated on a haptic device; generating a 3D user interface (UI) data model comprising one or more model definitions derived from the 3D model; generating a model definition for a 3D window, the 3D window able to be displayed in the 3D model; actively updating the 3D model with video data; displaying the 3D model; and receiving an input to navigate a point of view through the 3D model to determine which portions of the 3D model are displayed.

In general a method is provided for generating a height map from data points having spatial coordinates, the method comprising: obtaining a 3D model from the data points having spatial coordinates; generating an image of least a portion of the 3D model, the image comprising pixels; for a given pixel in the image, identifying one or more data points based on proximity to the given pixel; determining a height value based on the one or more data points; and associating the height value with the given pixel.

In another aspect, the 3D model is obtained from the data points having spatial coordinates by generating a shell surface of an object extracted from the data points having spatial coordinates. In another aspect, the shell surface is generated using Delaunay's triangulation algorithm. In another aspect, the 3D model comprises a number of polygons, and the method further comprises reducing the number of polygons. In another aspect, the 3D models comprises a number of polygons, and the image is of at least one polygon of the number of polygons. In another aspect, the one or more data points based on the proximity to the given pixel comprises a predetermined number of data points closest to the given pixel. In another aspect, the predetermined number of data points is one. In another aspect, the one or more data points based on the proximity to the given pixel are located within a predetermined distance of the given pixel. In another aspect, every pixel in the image is associated with a respective height value.

In general a method is provided for generating a color map from data points having spatial coordinates, the method comprising: obtaining a 3D model from the data points having spatial coordinates; generating an image of least a portion of the 3D model, the image comprising pixels; for a given pixel in the image, identifying a data point located closest to the given pixel; determining a color value of the data point located closest to the given pixel; and associating the color value with the given pixel.

In another aspect, the color value is a red-green-blue (RGB) value. In another aspect, the 3D model is obtained from the data points having spatial coordinates by generating a shell surface of an object extracted from the data points having spatial coordinates. In another aspect, the shell surface is generated using Delaunay's triangulation algorithm. In another aspect, the 3D model comprises a number of polygons, and the method further comprises reducing the number of polygons. In another aspect, the 3D models comprises a number of polygons, and the image is of at least one polygon of the number of polygons. In another aspect, every pixel in the image is associated with a respective color value.

In general, a method is provided for determining a material classification for a surface in a 3D model, the method comprising: providing a type of an object corresponding to the 3D model; providing an image corresponding to the surface in the 3D model, the image associated with a height mapping and a color mapping; and determining the material classification of the surface based on the type of the object, and at least one of the height mapping and the color mapping.

In another aspect, the material classification is associated with the object. In another aspect, the method further comprising selecting a material classification algorithm from a material classification database based on the type of the object. In another aspect, the method further comprising applying the material classification algorithm, which includes analyzing at least one of the height mapping and the color mapping. In another aspect, the 3D model is generated from data points having spatial coordinates. In another aspect, the type of the object is any one of a building wall, a building roof, and a road. In another aspect, the type of the object is the building wall if the object is approximately perpendicular to a ground surface in the 3D model; the type of the object is the building roof if the object is approximately perpendicular to the building wall; and the type of the object is the road if the object is approximately parallel to the ground surface. In another aspect, the method further comprising increasing a contrast in color of the color mapping of the image. In another aspect, the type of the object is a wall, and the method further comprising, if there are no straight and parallel lines in the color mapping that are approximately horizontal relative to a ground surface in the 3D model, determining the material classification for the surface to be stucco. In another aspect, the type of the object is a wall, and the method further comprising: if there are straight and parallel lines in the color mapping that are approximately horizontal relative to a ground surface in the 3D model, and, if there are straight lines perpendicular to the straight and parallel lines, determining the material classification for the surface to be brick; and if there are straight and parallel lines in the color mapping that are approximately horizontal relative to a ground surface in the 3D model, and, if there are no straight lines perpendicular to the straight and parallel lines, determining the material classification for the surface to be siding. In another aspect, the type of the object is a wall, and the method further comprising, if there are rectangular shaped elevations or depressions in the height mapping, determining the material classification to be windowing material. In another aspect, the type of the object is a roof, and the method further comprising: if there are no straight and parallel lines in the color mapping, and if the surface is gray, determining the material classification to be gravel; and if there are no straight and parallel lines in the color mapping, and if the surface is black, determining the material classification to be asphalt. In another aspect, wherein the type of the object is a roof, and the method further comprising: if there are straight and parallel lines in the color mapping, and if there are straight lines perpendicular to the straight and parallel lines, determining the material classification for the surface to be shingles; and if there are straight and parallel lines in the color mapping, and if there are no straight lines perpendicular to the straight and parallel lines, determining the material classification for the surface to be tiles. In another aspect, the type of the object is a roof, and the method further comprising: if a height variance of the height mapping is lower than a threshold, determining the material classification for the surface to be any one of shingles, asphalt and gravel; and if not, determining the material classification for the surface to be tiling.

In general, a method of providing a haptic response is provided, the method comprising: displaying on a display screen a 2D image of a 3D model; detecting a location of a pointer on the display screen; correlating the location of the pointer on the 2D image with a 3D location on the 3D model; and if the 3D location corresponds with one or more features of the 3D model providing the haptic response.

In another aspect, the one or more features of the 3D model comprises at least a first polygon and a second polygon that are not co-planar with each other, and as the pointer moves from the first polygon to the second polygon, providing the haptic response. In another aspect, the one or more features comprises a change in depth of a surface on the 3D model, and as the pointer moves across the surface, providing the haptic response. In another aspect, the one or more features comprises a height map associated with the 3D model, the height map comprising one or more pixels each associated with a height, and as the pointer moves over a pixel in the height map that is raised or lowered over a surface of the 3D model, providing the haptic response. In another aspect, the one or more features of the 3D model comprises a surface that has a textured material classification, and as the pointer moves over the surface, providing the haptic response. In another aspect, the haptic response is provided by a haptic device. In another aspect, the haptic device comprises any one of a buzzer and a piezoelectric strip actuator.

In general, a method is provided for displaying a window on a display screen, the window defined by a polygon in a plane located in a 3D space, the method comprising: computing clipping planes projecting from each edge of the polygon, the clipping planes normal to the polygon; providing a 3D object in the window, a portion of the 3D object located within a space defined by the clipping planes and the polygon, and another portion of the 3D object located outside the space defined by the clipping planes and the polygon; computing a surface using a surface triangulation algorithm for the portion of the 3D object located within a space defined by the clipping planes and the polygon, the surface comprising triangles; and when displaying the 3D object on the display screen, rendering the triangles of the surface.

In another aspect, wherein: the polygon comprises vertices and boundary lines forming the edges of the polygon; at each vertex a vector that is normal to the plane is computed; and each clipping plane is defined by at least one vector that is normal to the plane and at least one edge. In another aspect, at least one of edge of at least one of the triangles, located within the portion of the 3D object located within the space defined by the clipping planes and the polygon, are flush with at least one edge of the polygon.

In general, a method is provided for displaying at least two 3D objects in a window on a display screen, the window defined by a polygon in a plane located in a 3D space, and a first 3D object having Z-order than a second 3D object, the method comprising: rendering a first virtual shape having a first outline matching the first 3D object, the first virtual shape comprising a first set of triangles; rendering a second virtual shape having a second outline matching the second 3D object, the second virtual shape comprising a second set of triangles; determining a portion of the second 3D object that is not occluded by the first 3D object; applying a surface triangulation algorithm for the portion of the second 3D object; and rendering the portion of the second 3D object.

In another aspect, the surface triangulation algorithm is a Delaunay triangulation algorithm. In another aspect, a Z-order of a third 3D object is higher than the Z-order of the first 3D object, the method further comprising: determining a portion of the first 3D object that is not occluded by the third 3D object; applying the surface triangulation algorithm for the portion of the first 3D object; and rendering the portion of the first 3D object.

In general, a method is provided for interacting with one or more 3D objects displayed on a display screen, the 3D objects located in a 3D space, the method comprising: determining a 2D location of a pointer on the display screen; computing a 3D ray from the 2D location to a 3D point in the 3D space; generating a 3D boundary around the 3D ray; identifying the one or more 3D objects that intersect the 3D boundary; identifying a 3D object, of the one or more 3D objects, that is closest to a point of view of the 3D space being displayed on the display screen; and providing a focus for interaction on the 3D object that is closest to the point of view.

In another aspect, if the 3D object, that is closest to the point of view, is interactive, upon receiving a user input associated with the pointer, performing an action.

In general, a method is provided for organizing a data for visualizing one or more 3D objects in a 3D space on a display screen, the method comprising: associating with the 3D space the one or more 3D objects; associating with the 3D space a point of view for viewing the 3D space, the point of view defined by at least a location in the 3D space; and associating with each of the or more 3D object a model definition, the model definition comprising a variable definition, a geometry definition, and a logic definition.

In another aspect, the variable definition comprises names of one or more variables and data types of the one or more variables. In another aspect, the logic definition comprises inputs, logic algorithms, and outputs. In another aspect, the geometry definition comprises data structures representing at least one of vertices, polygons, lines and textures. In another aspect, each of the one or more 3D objects is an instance of the model definition, the instance comprising a reference to the model definition and one or more variable values corresponding to the variable definition.

In general, a method is provided for encoding video data for a 3D model, the method comprising: detecting a surface in the video data that persistently appears over multiple video frames; determining a surface of the 3D model that corresponds with the surface in the video data; extracting 2D image data from the surface in the video data; and associating the 2D image data with an angle of incidence between a video sensor and the surface in the video data, wherein the video sensor has captured the video data.

In another aspect, the method further comprising deriving one or more surfaces from the video data, the surface in the video data being one of the one or more surfaces. In another aspect, the method further comprising detecting multiple surfaces in the video data that persistently appear over the multiple video frames, and if the number of the multiple surfaces in the video data that correspond to the 3D model is less than a threshold, new surfaces are derived from the video data.

In general, a method is provided for decoding video data encoded for a 3D model, the video data comprising a 2D image and an angle associated with a surface in the 3D model, the method comprising: covering the surface in the 3D model with the 2D image; and interpolating the 2D image based on at least the angle.

In another aspect, the angle is an angle of incidence between a video sensor and a surface in the video data, the surface in the video data corresponding to surface in the 3D model, wherein the video sensor has captured the video data. In another aspect, the 2D image is interpolated also based on an angle at which the 3D model is viewed.

In general, a method is provided for controlling a point of view when displaying a 3D space, the method comprising: selecting a focus point in the 3D space, the point of view having a location in the 3D space; computing a distance, an elevation angle and an azimuth angle between the focus point and the location of the point of view; receiving an input to change at least one of the distance, the elevation angle and the azimuth angle; and computing a new location of the point of view based on the input while maintaining the focus point.

In another aspect, the method further comprising selecting a new focus point in the 3D space for the point of view.

The above principles for viewing 3D spatial data may be applied to a number of industries including, for example, mapping, surveying, architecture, environmental conservation, power-line maintenance, civil engineering, real-estate, budding maintenance, forestry, city planning, traffic surveillance, animal tracking, clothing, product shipping, etc. The different software modules may be used alone or combined together.

The steps or operations in the flow charts described herein are just for example. There may be many variations to these steps or operations without departing from the spirit of the invention or inventions. For instance, the steps may be performed in a differing order, or steps may be added, deleted, or modified.

While the basic principles of this invention or these inventions have been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention or inventions, and not construed in a limiting sense.

1. A method for displaying data having spatial coordinates, the method comprising:
obtaining a 3D model, the 3D model comprising the data having spatial coordinates;
generating a height map from the data;
generating a color map from the data;
identifying and determining a material classification for one or more surfaces in the 3D model based on at least one of the height map and the color map;
based on at least one of the 3D model, the height map, the color map, and the material classification, generate one or more haptic responses, the haptic responses able to be activated on a haptic device;
generating a 3D user interface (UI) data model comprising one or more model definitions derived from the 3D model;
generating a model definition for a 3D window, the 3D window able to be displayed in the 3D model;
actively updating the 3D model with video data;
displaying the 3D model; and
receiving an input to navigate a point of view through the 3D model to determine which portions of the 3D model are displayed.

2. A method for generating a height map from data points having spatial coordinates, the method comprising:
obtaining a 3D model from the data points having spatial coordinates;
generating an image of least a portion of the 3D model, the image comprising pixels;
for a given pixel in the image, identifying one or more data points based on proximity to the given pixel;
determining a height value based on the one or more data points; and
associating the height value with the given pixel.

3. The method of claim 2 wherein the 3D model is obtained from the data points having spatial coordinates by generating a shell surface of an object extracted from the data points having spatial coordinates.

4. The method of claim 3 wherein the shell surface is generated using Delaunay's triangulation algorithm.

5. The method of claim 2 wherein the 3D model comprises a number of polygons, and the method further comprises reducing the number of polygons.

6. The method of claim 2 wherein the 3D models comprises a number of polygons, and the image is of at least one polygon of the number of polygons.

7. The method of claim 2 wherein the one or more data points based on the proximity to the given pixel comprises a predetermined number of data points closest to the given pixel.

8. The method of claim 7 wherein the predetermined number of data points is one.

9. The method of claim 2 wherein the one or more data points based on the proximity to the given pixel are located within a predetermined distance of the given pixel.

10. The method of claim 2 wherein every pixel in the image is associated with a respective height value.

11. A method for generating a color map from data points having spatial coordinates, the method comprising:
obtaining a 3D model from the data points having spatial coordinates;
generating an image of least a portion of the 3D model, the image comprising pixels;
for a given pixel in the image, identifying a data point located closest to the given pixel;
determining a color value of the data point located closest to the given pixel; and
associating the color value with the given pixel.

12. The method of claim 11 wherein the color value is a red-green-blue (RGB) value.

13. The method of claim 11 wherein the 3D model is obtained from the data points having spatial coordinates by generating a shell surface of an object extracted from the data points having spatial coordinates.

14. The method of claim 13 wherein the shell surface is generated using Delaunay's triangulation algorithm.

15. The method of claim 11 wherein the 3D model comprises a number of polygons, and the method further comprises reducing the number of polygons.

16. The method of claim 11 wherein the 3D models comprises a number of polygons, and the image is of at least one polygon of the number of polygons.

17. The method of claim 11 wherein every pixel in the image is associated with a respective color value.

18. A method for determining a material classification for a surface in a 3D model, the method comprising:
providing a type of an object corresponding to the 3D model;
providing an image corresponding to the surface in the 3D model, the image associated with a height mapping and a color mapping; and
determining the material classification of the surface based on the type of the object, and at least one of the height mapping and the color mapping.

19. The method of claim 18 wherein the material classification is associated with the object.

20. The method of claim 18 further comprising selecting a material classification algorithm from a material classification database based on the type of the object.

21.-59. (canceled)
